(19) United States
(12) Patent Application Publication
(10) Pub. No.: US 2024/0109037 A1
(43) Pub. Date: Apr. 4, 2024

(54) LIQUID SEPARATION USING SOLUTE-PERMEABLE MEMBRANES AND RELATED SYSTEMS

(71) Applicant: Gradiant Corporation, Woburn, MA (US)

(72) Inventors: Omkar Lokare, Arlington, MA (US); Richard Stover, Waltham, MA (US); Looh Tchuin Choong, Singapore (SG); Kurt Blohm, San Diego, CA (US); Ana Claudia Emerenciano Guedes, Somerville, MA (US)

(73) Assignee: Gradiant Corporation, Woburn, MA (US)

(21) Appl. No.: 18/315,130

(22) Filed: May 10, 2023

Related U.S. Application Data
(60) Provisional application No. 63/411,079, filed on Sep. 28, 2022.

(51) Int. Cl. B01D 61/02; B01D 69/02; C02F 1/44

(52) U.S. Cl. CPC B01D 61/026; B01D 69/02; C02F 1/441; B01D 2317/022; B01D 2317/025; B01D 2317/04; B01D 2325/34; C02F 2103/08

(57) ABSTRACT

Liquid solution separation (e.g., concentration and/or desalination) methods and related systems involving membrane separators having at least one-semipermeable membrane are provided. In some instances, at least some of the membrane separators permit a portion of solute in a retentate side input stream to pass through the semi-permeable membrane. In some instances, multiple membrane separators are employed, with the membrane separators having different solute permeabilities (e.g., due to varying pore size and/or molecular weight cutoffs). The methods and systems may be configured such that the ratio of mass flow and/or concentration of solute entering the retentate sides of the membrane separators are relatively high compared to the mass flow and/or concentration of solute exiting the retentate sides of the membrane separators. Such ratios may be relatively high for some or all membrane separators employed, which can in some instances reduce capital and/or operational expenditures for the liquid separation processes.

### RELATED APPLICATIONS

This application claims priority under 35 U.S.C. § 119(e) to U.S. Provisional Patent Application No. 63/411,079, filed Sep. 28, 2022, and entitled “Liquid Separation Using Solute-Permeable Membranes and Related Systems,” which is incorporated herein by reference in its entirety for all purposes.

### TECHNICAL FIELD

Liquid solution separation methods and related systems are generally described.

### BACKGROUND

Membranes which are selectively permeable to liquid and comparatively less permeable to solutes have been used to purify feed streams. As one example, membrane-based desalination has been used to desalinate aqueous feed streams. In one such purification process—generally referred to as forward osmosis—liquid (e.g., a solvent such as water) is transported from a feed stream through a semi-permeable membrane by applying a draw solution (also sometimes referred to as a sweep solution) to the permeate side of the membrane that has an osmotic pressure that is higher than the osmotic pressure of the feed stream. The driving force for separation in a forward osmosis process is the osmotic pressure difference across the semi-permeable membrane; because the draw solution on one side of the membrane has a higher osmotic pressure than the feed stream on the other side of the membrane, the liquid is drawn through the semi-permeable membrane from the feed stream to the draw solution to equalize the osmotic pressures.

Another type of membrane-based solution concentration process is reverse osmosis. In contrast to forward osmosis, reverse osmosis processes use an applied hydraulic pressure as the driving force for separation. The applied hydraulic pressure serves to counteract the osmotic pressure difference that would otherwise favor liquid flux from low osmotic pressure to high osmotic pressure. Therefore in reverse osmosis systems, liquid is driven from the high osmotic pressure side to the low osmotic pressure side.

Many membrane-based solution concentration systems have, to date, been limited by, for example, low efficiencies, low concentration limits, large expense, and undesired fouling and scaling. Improved systems and methods for performing membrane-based solution concentration are desirable.

### SUMMARY

Liquid solution separation (e.g., liquid concentration and/or desalination) methods and related systems involving membrane separators having at least one-semipermeable membrane are provided. The subject matter of the present invention involves, in some cases, interrelated products, alternative solutions to a particular problem, and/or a plurality of different uses of one or more systems and/or articles.

In one aspect, methods of treating a feed stream comprising a liquid and a solute are provided. In some embodiments, the method comprises transporting a first membrane separator retentate inlet stream to a retentate side of a first membrane separator such that: a first membrane separator retentate outlet stream exits the retentate side of the first membrane separator, the first membrane separator retentate outlet stream having an osmotic pressure that is greater than an osmotic pressure of the first membrane separator retentate inlet stream, and at least a portion of liquid from the first membrane separator retentate inlet stream is transported from the retentate side of the first membrane separator, through a semi-permeable membrane of the first membrane separator, to a permeate side of the first membrane separator; and transporting a second membrane separator retentate inlet stream to a retentate side of a second membrane separator such that: a second membrane separator retentate outlet stream exits the retentate side of the second membrane separator, the second membrane separator retentate outlet stream having an osmotic pressure that is greater than an osmotic pressure of the second membrane separator retentate inlet stream, and at least a portion of liquid and solute from the second membrane separator retentate inlet stream is transported from the retentate side of the second membrane separator, through a semi-permeable membrane of the second membrane separator, to a permeate side of the second membrane separator where the portion of the liquid and solute forms some or all of a second membrane separator permeate outlet stream that is transported out of the permeate side of the second membrane separator; wherein: the first membrane separator retentate inlet stream comprises at least a portion of the feed stream; the second membrane separator retentate inlet stream comprises at least a portion of the first membrane separator retentate outlet stream; a salt passage percentage at standard conditions of the first membrane separator is different than a salt passage percentage at standard conditions of the second membrane separator, wherein the salt passage percentage at standard conditions is determined using ASTM D4516-19a; and the first membrane separator has a solute enhancement factor during the step of transporting the first membrane separator retentate inlet stream to the retentate side of the first membrane separator, the second membrane separator has a solute enhancement factor during the step of transporting the second membrane separator retentate inlet stream to the retentate side of the second membrane separator, and the arithmetic average of the solute enhancement factor of the first membrane separator and the solute enhancement factor of the second membrane separator is greater than or equal to 1.005.

In some embodiments, the method comprises transporting a first membrane separator retentate inlet stream to a retentate side of a first membrane separator such that: a first membrane separator retentate outlet stream exits the retentate side of the first membrane separator, the first membrane separator retentate outlet stream having an osmotic pressure that is greater than an osmotic pressure of the first membrane separator retentate inlet stream, and at least a portion of liquid from the first membrane separator retentate inlet stream is transported from the retentate side of the first membrane separator, through a semi-permeable membrane of the first membrane separator, to a permeate side of the first membrane separator; and transporting a second membrane separator retentate inlet stream to a retentate side of a second membrane separator such that: a second membrane separator retentate outlet stream exits the retentate side of the second membrane separator, the second membrane separator retentate outlet stream having an osmotic pressure that is greater than an osmotic pressure of the second membrane separator retentate inlet stream, and at least a portion of liquid and solute from the second membrane separator retentate inlet stream is transported from the retentate side of the second membrane separator, through a semi-permeable membrane of the second membrane separator, to a permeate side of the second membrane separator where the portion of the liquid and solute forms some or all of a second membrane separator permeate outlet stream that is transported out of the permeate side of the second membrane separator; wherein: the first membrane separator retentate inlet stream comprises at least a portion of the feed stream; the second membrane separator retentate inlet stream comprises at least a portion of the first membrane separator retentate outlet stream; a salt passage percentage at standard conditions of the first membrane separator is different than a salt passage percentage at standard conditions of the second membrane separator, wherein the salt passage percentage at standard conditions is determined using ASTM D4516-19a; and the first membrane separator has a mass flow ratio during the step of transporting the first membrane separator retentate inlet stream to the retentate side of the first membrane separator, the second membrane separator has a mass flow ratio during the step of transporting the second membrane separator retentate inlet stream to the retentate side of the second membrane separator, and the arithmetic average of the mass flow ratio of the first membrane separator and the mass flow ratio factor of the second membrane separator is greater than or equal to 1.005.

In some embodiments, the method comprises transporting a first membrane separator retentate inlet stream to a retentate side of a first membrane separator such that: a first membrane separator retentate outlet stream exits the retentate side of the first membrane separator, the first membrane separator retentate outlet stream having an osmotic pressure that is greater than an osmotic pressure of the first membrane separator retentate inlet stream, and at least a portion of liquid from the first membrane separator retentate inlet stream is transported from the retentate side of the first membrane separator, through a semi-permeable membrane of the first membrane separator, to a permeate side of the first membrane separator; transporting a second membrane separator retentate inlet stream to a retentate side of a second membrane separator such that: a second membrane separator retentate outlet stream exits the retentate side of the second membrane separator, the second membrane separator retentate outlet stream having an osmotic pressure that is greater than an osmotic pressure of the second membrane separator retentate inlet stream, and at least a portion of liquid and solute from the second membrane separator retentate inlet stream is transported from the retentate side of the second membrane separator, through a semi-permeable membrane of the second membrane separator, to a permeate side of the second membrane separator where the portion of the liquid and solute forms some or all of a second membrane separator permeate outlet stream that is transported out of the permeate side of the second membrane separator; and transporting a third membrane separator retentate inlet stream to a retentate side of a third membrane separator such that: a third membrane separator retentate outlet stream exits the retentate side of the third membrane separator, the third membrane separator retentate outlet stream having an osmotic pressure that is greater than an osmotic pressure of the third membrane separator retentate inlet stream, and at least a portion of liquid and solute from the third membrane separator retentate inlet stream is transported from the retentate side of the third membrane separator, through a semi-permeable membrane of the third membrane separator, to a permeate side of the third membrane separator where the portion of the liquid and solute forms some or all of a third membrane separator permeate outlet stream that is transported out of the permeate side of the third membrane separator; wherein: the first membrane separator retentate inlet stream comprises at least a portion of the second membrane separator permeate outlet stream and/or at least a portion of the third membrane separator permeate outlet stream; the second membrane separator retentate inlet stream and/or the third membrane separator retentate inlet stream comprises at least a portion of the feed stream; the second membrane separator retentate inlet stream comprises at least a portion of the first membrane separator retentate outlet stream; the third membrane separator retentate inlet stream comprises at least a portion of the second membrane separator retentate outlet stream; a salt passage percentage at standard conditions of the first membrane separator is different than a salt passage percentage at standard conditions of the second membrane separator, wherein the salt passage percentage at standard conditions is determined using ASTM D4516-19a; and the first membrane separator has a solute enhancement factor during the step of transporting the first membrane separator retentate inlet stream to the retentate side of the first membrane separator, the second membrane separator has a solute enhancement factor during the step of transporting the second membrane separator retentate inlet stream to the retentate side of the second membrane separator, and the arithmetic average of the solute enhancement factor of the first membrane separator and the solute enhancement factor of the second membrane separator is greater than or equal to 1.005.

In some embodiments, the method comprises transporting a first membrane separator retentate inlet stream to a retentate side of a first membrane separator such that: a first membrane separator retentate outlet stream exits the retentate side of the first membrane separator, the first membrane separator retentate outlet stream having an osmotic pressure that is greater than an osmotic pressure of the first membrane separator retentate inlet stream, and at least a portion of liquid from the first membrane separator retentate inlet stream is transported from the retentate side of the first membrane separator, through a semi-permeable membrane of the first membrane separator, to a permeate side of the first membrane separator; transporting a second membrane separator retentate inlet stream to a retentate side of a second membrane separator such that: a second membrane separator retentate outlet stream exits the retentate side of the second membrane separator, the second membrane separator retentate outlet stream having an osmotic pressure that is greater than an osmotic pressure of the second membrane separator retentate inlet stream, and at least a portion of liquid and solute from the second membrane separator retentate inlet stream is transported from the retentate side of the second membrane separator, through a semi-permeable membrane of the second membrane separator, to a permeate side of the second membrane separator where the portion of the liquid and solute forms some or all of a second membrane separator permeate outlet stream that is transported out of the permeate side of the second membrane separator; and transporting a third membrane separator retentate inlet stream to a retentate side of a third membrane separator such that: a third membrane separator retentate outlet stream exits the retentate side of the third membrane separator, the third membrane separator retentate outlet stream having an osmotic pressure that is greater than an osmotic pressure of the third membrane separator retentate inlet stream, and at least a portion of liquid and solute from the third membrane separator retentate inlet stream is transported from the retentate side of the third membrane separator, through a semi-permeable membrane of the third membrane separator, to a permeate side of the third membrane separator where the portion of the liquid and solute forms some or all of a third membrane separator permeate outlet stream that is transported out of the permeate side of the third membrane separator; wherein: the first membrane separator retentate inlet stream comprises at least a portion of the second membrane separator permeate outlet stream and/or at least a portion of the third membrane separator permeate outlet stream; the second membrane separator retentate inlet stream and/or the third membrane separator retentate inlet stream comprises at least a portion of the feed stream; the second membrane separator retentate inlet stream comprises at least a portion of the first membrane separator retentate outlet stream; the third membrane separator retentate inlet stream comprises at least a portion of the second membrane separator retentate outlet stream; a salt passage percentage at standard conditions of the first membrane separator is different than a salt passage percentage at standard conditions of the second membrane separator, wherein the salt passage percentage at standard conditions is determined using ASTM D4516-19a; and the first membrane separator has a mass flow ratio during the step of transporting the first membrane separator retentate inlet stream to the retentate side of the first membrane separator, the second membrane separator has a mass flow ratio during the step of transporting the second membrane separator retentate inlet stream to the retentate side of the second membrane separator, and the arithmetic average of the mass flow ratio of the first membrane separator and the mass flow ratio factor of the second membrane separator is greater than or equal to 1.005.

In another aspect, systems are provided. In some embodiments, the system comprises a plurality of membrane separators comprising: a first membrane separator comprising at least one semi-permeable membrane defining a retentate side of the first membrane separator and a permeate side of the first membrane separator; and a second membrane separator comprising at least one semi-permeable membrane defining a retentate side of the second membrane separator and a permeate side of the second membrane separator; wherein: the retentate side of the first membrane separator is fluidically connected to the retentate side of the second membrane separator; the first membrane separator has a different salt passage percentage at standard conditions than the second membrane separator, wherein the salt passage percentage at standard conditions is determined using ASTM D4516-19a; and for an initial feed stream containing NaCl as the only solute and water as the only liquid, and having a salinity of 7%, at a temperature of 298 K, each of the plurality of membrane separators has a solute enhancement factor, and the arithmetic average of the solute enhancement factors of the plurality of membrane separators is greater than or equal to 1.005.

In some embodiments, the system comprises a plurality of membrane separators comprising: a first membrane separator comprising at least one semi-permeable membrane defining a retentate side of the first membrane separator and a permeate side of the first membrane separator; and a second membrane separator comprising at least one semi-permeable membrane defining a retentate side of the second membrane separator and a permeate side of the second membrane separator; wherein: the retentate side of the first membrane separator is fluidically connected to the retentate side of the second membrane separator; the first membrane separator has a different salt passage percentage at standard conditions than the second membrane separator, wherein the salt passage percentage at standard conditions is determined using ASTM D4516-19a; and for an initial feed stream containing NaCl as the only solute and water as the only liquid, and having a salinity of 20%, at a temperature of 298 K, each of the plurality of membrane separators has a solute enhancement factor, and the arithmetic average of the solute enhancement factors of the plurality of membrane separators is greater than or equal to 1.005.

In some embodiments, the system comprises a plurality of membrane separators comprising: a first membrane separator comprising at least one semi-permeable membrane defining a retentate side of the first membrane separator and a permeate side of the first membrane separator; and a second membrane separator comprising at least one semi-permeable membrane defining a retentate side of the second membrane separator and a permeate side of the second membrane separator; wherein: the retentate side of the first membrane separator is fluidically connected to the retentate side of the second membrane separator; the first membrane separator has a different salt passage percentage at standard conditions than the second membrane separator, wherein the salt passage percentage at standard conditions is determined using ASTM D4516-19a; and for an initial feed stream containing NaCl as the only solute and water as the only liquid, and having a salinity of 7%, at a temperature of 298 K, each of the plurality of membrane separator has a mass flow ratio, and the arithmetic average of the mass flow ratios of the plurality of membrane separators is greater than or equal to 1.005.

In some embodiments, the system comprises a plurality of membrane separators comprising: a first membrane separator comprising at least one semi-permeable membrane defining a retentate side of the first membrane separator and a permeate side of the first membrane separator; and a second membrane separator comprising at least one semi-permeable membrane defining a retentate side of the second membrane separator and a permeate side of the second membrane separator; wherein: the retentate side of the first membrane separator is fluidically connected to the retentate side of the second membrane separator; the first membrane separator has a different salt passage percentage at standard conditions than the second membrane separator, wherein the salt passage percentage at standard conditions is determined using ASTM D4516-19a; and for an initial feed stream containing NaCl as the only solute and water as the only liquid, and having a salinity of 20%, at a temperature of 298 K, each of the plurality of membrane separator has a mass flow ratio, and the arithmetic average of the mass flow ratios of the plurality of membrane separators is greater than or equal to 1.005. In another aspect, membrane separators are provided. In some embodiments, the membrane separator comprises at least one semi-permeable membrane defining a retentate side of the first membrane separator and a permeate side of the first membrane separator, wherein for an initial feed stream containing NaCl as the only solute and water as the only liquid, and having salinity of 7%, at a temperature of 298 K, the membrane separator has a solute enhancement factor and/or mass flow ratio of greater than or equal to 1.005.

In some embodiments, the membrane separator comprises at least one semi-permeable membrane defining a retentate side of the first membrane separator and a permeate side of the first membrane separator, wherein for an initial feed stream containing NaCl as the only solute and water as the only liquid, and having salinity of 20%, at a temperature of 298 K, the membrane separator has a solute enhancement factor and/or mass flow ratio of greater than or equal to 1.005.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic diagram of a system comprising a membrane separator that receives at least a portion of a feed stream and produces a retentate outlet stream, according to some embodiments;

FIG. 2A is a schematic diagram of a system comprising a first membrane separator and a second membrane separator, according to some embodiments;

FIG. 2B is a schematic diagram of a system comprising a first membrane separator, a second membrane separator, and an upstream membrane separator, according to some embodiments;

FIG. 3A is a schematic diagram of a system comprising a first membrane separator, a second membrane separator, and a third membrane separator, according to some embodiments;

FIG. 3B-3D are schematic diagrams of a system comprising a first membrane separator, a second membrane separator, and a third membrane separator, according to some embodiments;

FIG. 4A is a plot of recovery percentage versus feed salinity for various examples of membranes;

FIG. 4B is a plot of rejection percentage versus feed salinity for various examples of membranes;

FIG. 5A is a schematic illustration of a single-membrane membrane separator, according to some embodiments;

FIG. 5B is a schematic illustration of a membrane separator comprising multiple semi-permeable membranes fluidically connected in parallel, according to some embodiments;

FIG. 5C is a schematic illustration of a membrane separator comprising multiple semi-permeable membranes fluidically connected in series, according to some embodiments;

FIG. 6 is a flow diagram of an example of a process design for liquid separation, according to some embodiments;

FIG. 7A is a flow diagram of a process design for liquid separation with constant membrane separator permeability;

FIG. 7B is a flow diagram of a process design for liquid separation with varying membrane separator permeability, according to some embodiments;

FIG. 8A is a schematic diagram of a system comprising a first membrane separator and a second membrane separator, according to some embodiments;

FIG. 8B-8D are schematic diagrams of a system comprising a first membrane separator, a second membrane separator, and a third membrane separator, according to some embodiments; and

FIG. 9A-9C are schematic diagrams of a system comprising a first membrane separator, a second membrane separator, and a third membrane separator, according to some embodiments.

### DETAILED DESCRIPTION

Liquid solution separation (e.g., concentration and/or desalination) methods and related systems involving membrane separators having at least one-semipermeable membrane are provided. Separation at the membranes may occur via diffusion (e.g., as in osmotic separation), pore-based filtration (e.g., as in nanofiltration), or a combination of the two. In some instances, at least some of the membrane separators permit a portion of solute in a retentate side input stream to pass through the semi-permeable membrane. In some instances, multiple membrane separators are employed, with the membrane separators having different solute permeabilities (e.g., due to varying pore size, active layer morphologies, and/or molecular weight cutoffs). The methods and systems of this disclosure may be configured such that the ratio of mass flow and/or concentration of solute entering the retentate sides of the membrane separators are relatively high compared to the mass flow and/or concentration of solute exiting the retentate sides of the membrane separators. Such ratios may be relatively high for some or all membrane separators employed, which can in some instances reduce capital and/or operational expenditures for the liquid separation processes.

In some membrane-based separation processes, such as reverse osmosis and nanofiltration, hydraulic pressure is applied to promote passage of liquid through a semi-permeable membrane. In many such systems, the amount of hydraulic pressure required to cause passage of liquid through the membrane scales with the difference in solute concentration and/or osmotic pressure between the retentate side and the permeate side of the membrane. It can be desirable to configure systems and methods to reduce the required hydraulic pressure for a given solute concentration and/or osmotic pressure in order to promote energetic efficiency, an increase in concentration limits, and/or promote the durability of the system. It has been realized that one way to reduce required hydraulic pressure is to permit a greater portion of the influent solute to pass through the membrane compared to high-rejection (e.g., 99.9% rejection or 100% rejection) reverse osmosis (RO) membranes. Highly saline streams may be treated (e.g., desalinated) with such a membrane configuration because the higher solute permeability can reduce the required hydraulic pressure. In some instances, the membranes are configured such that a greater portion of the influent solute (e.g., solute ions) are rejected by the membrane as compared to nanofiltration (NF) membranes, reducing permeate salinity and increasing retentate outlet salinity. It is believed that highly concentrated streams can be produced using such membranes as compared to lower-rejection nanofiltration membranes because the lower ion permeability increases the degree of separation. But, it has also been realized in the context of this disclosure that performance of at least some membrane-based separation systems is based, at least in part, on the amount of permeate generated by the membranes and the extent of separation carried out by the membrane at a given operating condition. In the context of this disclosure, the amount of permeate generated (defined as a percentage calculated by dividing the value of the permeate outlet mass flow by the value of the retentate inlet mass flow and multiplying by 100) at a membrane separator is referred to as “recovery”. Also in the context of this disclosure, the extent of separation is described by the “rejection” of the membrane, as explained in more detail below. Generally, an increase in the feed salinity for a membrane results in a decrease in the recovery as well as rejection achieved by the membrane. Decreased recovery and rejection can result in poor membrane performance, and in such a case a substantially larger amount of membrane area may be required to separate certain liquids (e.g., to desalinate higher salinity waters).

One way to address the issues described above is to employ systems having multiple stages (e.g., membrane separators), where the retentate outlet stream from a previous stage is transported to the next stage as the retentate inlet stream for further concentration. At least because water permeability decreases substantially with increasing salinity (or solute concentration), the ability of a given membrane in subsequent stages to concentrate the stream further can become limited. In some embodiments, this potential problem for system performance is addressed at least in part by using membranes with varying (e.g., in some instances increasing) permeability as a function of increasing salinity in a multiple stage system. Further, the membranes may be arranged, and system operated, such that liquid separation performance parameters that account for rejection and/or recovery are relatively high (and in some instances consistent) across multiple stages. These parameters may include the “solute enhancement factor” (CF_{C}) and the “mass flow ratio” (CF_{M}) parameters described in more detail below.

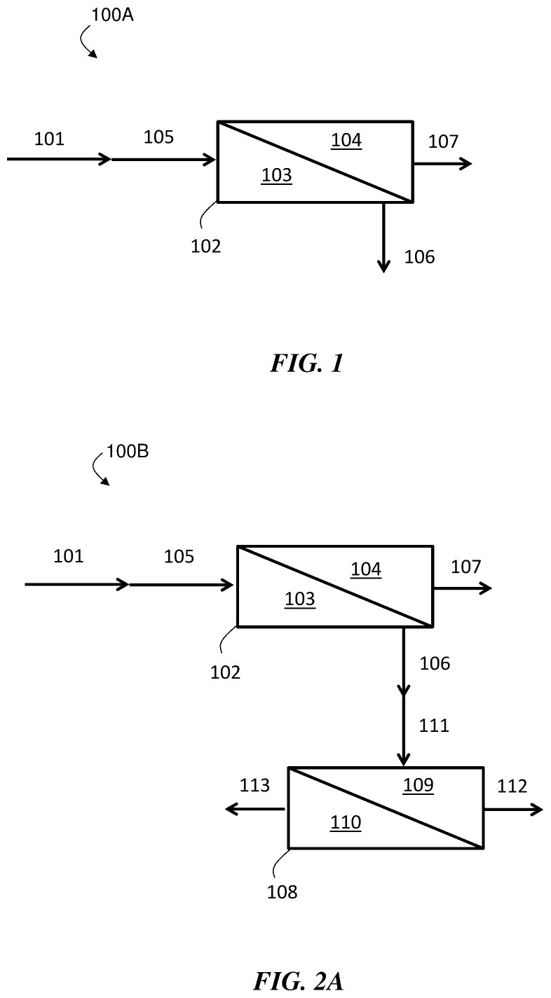

Methods (e.g., for concentrating liquids) and related systems are generally described. FIGS. 1-3D and 8A-9C show schematic illustrations of systems 100A, 100B, 100C, 100D, 100E, and 100F, respectively, which are examples of systems in which certain methods described herein may be carried out. The systems of this disclosure may comprise a single membrane separator or a plurality of membrane separators.

Some embodiments comprise treating a feed stream comprising a liquid and a solute (e.g., for liquid concentration and/or desalination). Examples of types of feed streams that can be treated according to the methods and using the systems of this disclosure are described in more detail below. Referring again to FIGS. 1-3D and 8A-9C, feed stream 101 may be fed into system 100 for treatment. In some embodiments, a hydraulic pressure of the feed stream is increased (e.g., via a pump to facilitate liquid separation). For example, in some embodiments, the feed stream is increased via a pump and/or energy recovery device (e.g., prior to the feed stream encountering a membrane separator).

Some embodiments comprise transporting a first membrane separator retentate inlet stream to a retentate side of a first membrane separator. A membrane separator refers to a collection of components including one or more semi-permeable membranes configured to perform a membrane-based separation process (e.g., an osmotic process, a filtration process, or a combination thereof) on at least one input stream and produce at least one output stream. The first membrane separator may comprise at least one semi-permeable membrane defining a permeate side of the first membrane separator and a retentate side of the first membrane separator. Each membrane separator described herein may include further sub-units such as, for example, individual semi-permeable membrane modules (e.g., in the form of cartridges), valving, fluidic conduits, and the like. As described in more detail below, each membrane separator can include a single semi-permeable membrane or multiple semi-permeable membranes. In some embodiments, a single membrane separator can include multiple sub-units (e.g., multiple modules such as multiple cartridges) that may or may not share a common container.

In some embodiments, a first membrane separator retentate inlet stream (which may comprise at least a portion (e.g., at least 5 wt %, at least 10 wt %, at least 20 wt %, at least 50 wt %, at least 80 wt %, at least 90 wt %, at least 95 wt %, at least 99 wt %, or more) of the feed stream, optionally with one or more other streams) is transported to a retentate side of a first membrane separator such that a first membrane separator retentate outlet stream exits the retentate side of the first membrane separator, the first membrane separator retentate outlet stream having an osmotic pressure that is greater (e.g., by a factor of at least 1.03, at least 1.035, at least 1.05, at least 1.10, at least 1.25, and/or up to 1.40, up to 1.50, up to 2, up to 3, up to 4, up to 5 or greater) than an osmotic pressure of the first membrane separator retentate inlet stream. For example, referring again to FIGS. 1-3D and 8A-9C, first membrane separator 102 may comprise at least one semi-permeable membrane defining retentate side 103 and permeate side 104, and first membrane separator retentate inlet stream 105 may be transported to retentate side 103 such that first membrane separator retentate outlet stream 106 exits retentate side 103. In some embodiments, such as those shown in FIGS. 1-3D, first membrane separator retentate inlet stream 105 comprises at least a portion of feed stream 101. This step may be performed such that first membrane separator retentate outlet stream 106 has an osmotic pressure that is greater than an osmotic pressure of first membrane separator retentate inlet stream 105, according to some embodiments. For example, this step may be performed such that first membrane separator retentate outlet stream 106 has a concentration of the solute that is increased with respect to the concentration of first membrane separator retentate inlet stream 105 (e.g., by a factor of at least 1.03, at least 1.035, at least 1.05, at least 1.10, at least 1.25, and/or up to 1.40, up to 1.50, up to 2, up to 3, up to 4, up to 5 or greater). In some embodiments, a hydraulic pressure is applied (e.g., to facilitate transport of liquid and/or solute from the retentate side to the permeate side). In some embodiments, the system is operated such that the first membrane separator retentate inlet stream has a hydraulic pressure of at least 200 psi (at least 1.38×10³ kPa), at least 500 psi (at least 3.45×10³ kPa), at least 750 psi (at least 5.17×10³ kPa), at least 1000 psi (at least 6.90×10³ kPa), and/or up to 1500 psi (up to 1.03×10⁴ kPa), up to 2000 psi (up to 1.38×10⁴ kPa), or more.

In some embodiments, at least a portion (e.g., at least 5 wt %, at least 10 wt %, at least 20 wt %, at least 50 wt %, at least 80 wt %, and/or up to 90 wt %, up to 95 wt %, up to 99 wt %, or more) of liquid from the first membrane separator retentate inlet stream is transported from the retentate side of the first membrane separator, through a semi-permeable membrane of the first membrane separator, to a permeate side of the first membrane separator. Referring again to FIGS. 1-3D and 8A-9C, for example, at least a portion of liquid from first membrane separator retentate inlet stream 105 may be transported from retentate side 103, through a semi-permeable membrane, to permeate side 104. Liquid transported from the retentate side to the permeate side of the first membrane separator may form some or all of a first membrane separator permeate outlet stream (e.g., first membrane separator permeate outlet stream 107 in FIGS. 1-3D and 8A-9C), which may be discharged from the system (e.g., as relatively pure liquid such as relatively pure water). In some embodiments, the first membrane separator retentate inlet stream comprises at least a portion (e.g., at least 5 wt %, at least 10 wt %, at least 20 wt %, at least 50 wt %, at least 80 wt %, and/or up to 90 wt %, up to 95 wt %, up to 99 wt %, or more) of the first membrane separator permeate outlet stream.

In some, but not necessarily all embodiments, a portion (e.g., at least 5 wt %, at least 10 wt %, at least 20 wt %, at least 50 wt %, at least 80 wt %, and/or up to 85 wt %, up to 90 wt %, or more) of solute from the first membrane separator retentate inlet stream is transported from the retentate side of the first membrane separator, through a semi-permeable membrane of the first membrane separator, to a permeate side of the first membrane separator. However, in some embodiments, little or none (e.g., less than or equal to 10 wt %, less than or equal to 5 wt %, less than or equal to 2 wt %, less than or equal to 1 wt %, less than or equal to 0.1 wt %, or less) of the solute from the first membrane separator retentate inlet stream is transported from the retentate side of the first membrane separator, through a semi-permeable membrane of the first membrane separator, to a permeate side of the first membrane separator.

In some embodiments, one or more membrane separators (e.g., the first membrane separator) is operated as an osmotic separator. For example, in some embodiments, the semi-permeable membrane is an osmotic membrane. Transport of solvent (e.g., water) through osmotic membrane(s) of membrane separators can be achieved via a transmembrane net driving force (i.e., a net driving force through the thickness of the membrane(s)), according to certain embodiments. Generally, the transmembrane net driving force (Δχ) is expressed as:

Δχ=ΔP−AΠ=(P₁−P₂)−(Π₁−Π₂) [1]

wherein P₁ is the hydraulic pressure on the retentate side of the osmotic membrane, P₂ is the hydraulic pressure on the permeate side of the osmotic membrane, Π₁ is the osmotic pressure of the stream on the retentate side of the osmotic membrane, and Π₂ is the osmotic pressure of the stream on the permeate side of the osmotic membrane. (P₁− P₂) can be referred to as the transmembrane hydraulic pressure difference, and (Π₁−Π₂) can be referred to as the transmembrane osmotic pressure difference.

Those of ordinary skill in the art are familiar with the concept of osmotic pressure. The osmotic pressure of a particular liquid is an intrinsic property of the liquid. The osmotic pressure can be determined in a number of ways, with the most efficient method depending upon the type of liquid being analyzed. For certain solutions with relatively low molar concentrations of ions, osmotic pressure can be accurately measured using an osmometer. In other cases, the osmotic pressure can simply be determined by comparison with solutions with known osmotic pressures. For example, to determine the osmotic pressure of an uncharacterized solution, one could apply a known amount of the uncharacterized solution on one side of a non-porous, semi-permeable, osmotic membrane and iteratively apply different solutions with known osmotic pressures on the other side of the osmotic membrane until the differential pressure through the thickness of the membrane is zero.

The osmotic pressure (Π) of a solution containing n solubilized species may be estimated as:

Π=Σⱼ₌₁ⁿiⱼMⱼRT [2]

wherein iⱼ is the van't Hoff factor of the j^{th} solubilized species, Mⱼ is the molar concentration of the j^{th} solubilized species in the solution, R is the ideal gas constant, and T is the absolute temperature of the solution. Equation 2 generally provides an accurate estimate of osmotic pressure for liquid with low concentrations of solubilized species (e.g., concentrations at or below between about 4 wt % and about 6 wt %). For many liquid comprising solubilized species, at species concentrations above around 4-6 wt %, the increase in osmotic pressure per increase in salt concentration is greater than linear (e.g., slightly exponential).

As mentioned above, one type of osmotic separation technique that can be performed using the membrane separators of this disclosure, according to some embodiments, is reverse osmosis. Reverse osmosis generally occurs when the osmotic pressure on the retentate side of the osmotic membrane is greater than the osmotic pressure on the permeate side of the osmotic membrane, and a pressure is applied to the retentate side of the osmotic membrane such that the hydraulic pressure on the retentate side of the osmotic membrane is sufficiently greater than the hydraulic pressure on the permeate side of the osmotic membrane such that the osmotic pressure difference is overcome and liquid (e.g., a solvent such as water) is transported from the retentate side of the osmotic membrane to the permeate side of the osmotic membrane. Generally, such situations result when the transmembrane hydraulic pressure difference (P₁−P₂) is greater than the transmembrane osmotic pressure difference (Π₁−Π₂) such that liquid (e.g., a solvent such as water) is transported from the retentate side of the osmotic membrane to the permeate side of the osmotic membrane (rather than having liquid be transported from the permeate side of the osmotic membrane to the retentate side of the osmotic membrane, which would be energetically favored in the absence of the pressure applied to the retentate side of the osmotic membrane). In some embodiments, the first membrane separator is operated to perform reverse osmosis.

Some embodiments comprise transporting a second membrane separator retentate inlet stream to a retentate side of a second membrane separator. The second membrane separator may comprise at least one semi-permeable membrane defining a permeate side of the second membrane separator and a retentate side of the second membrane separator.

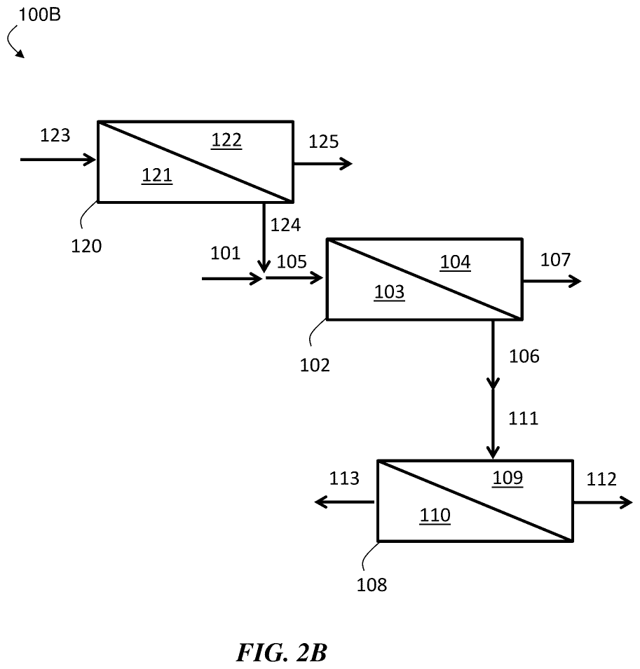

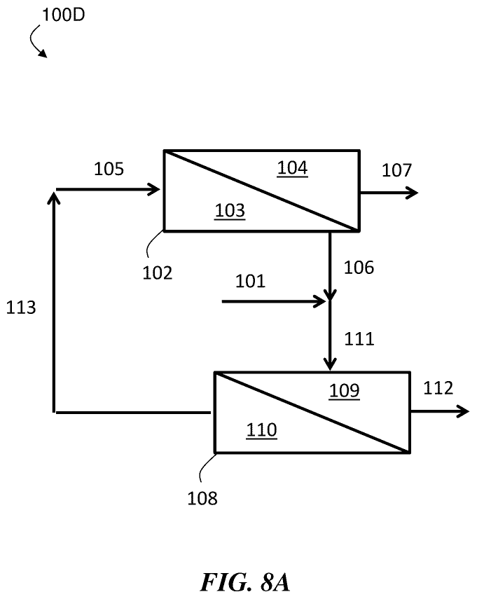

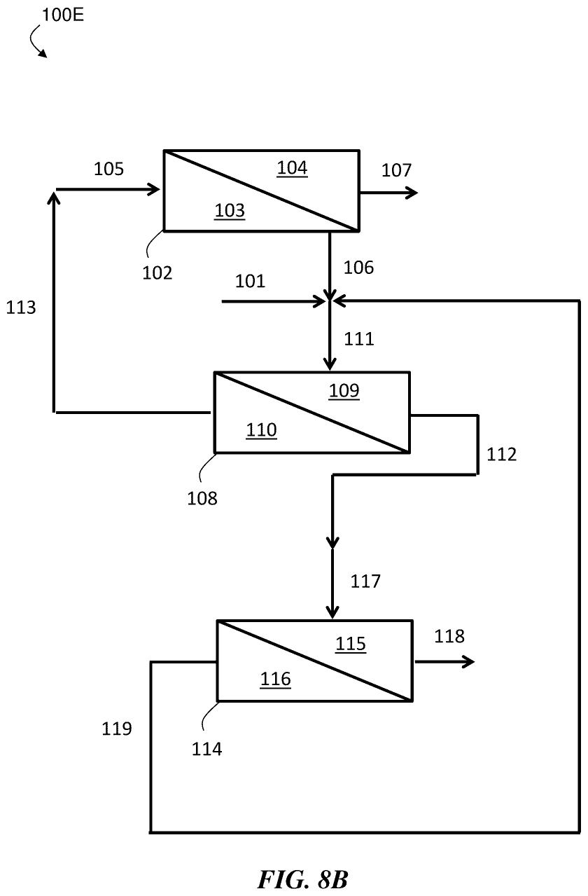

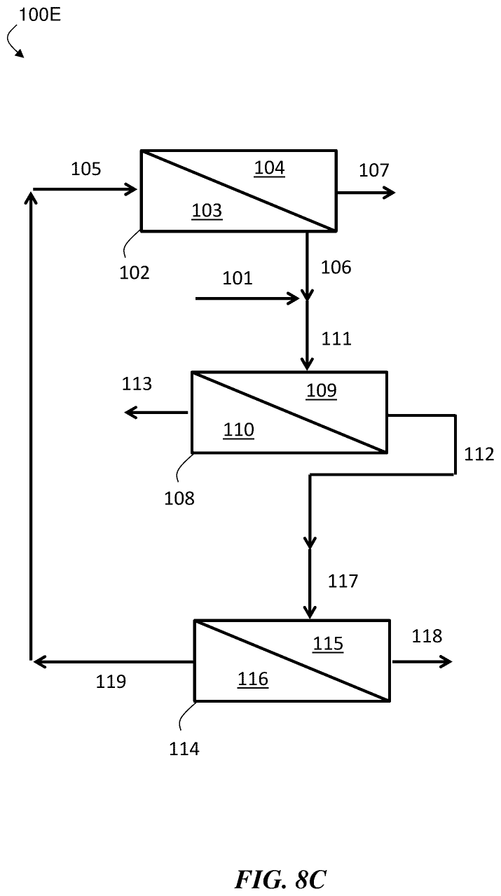

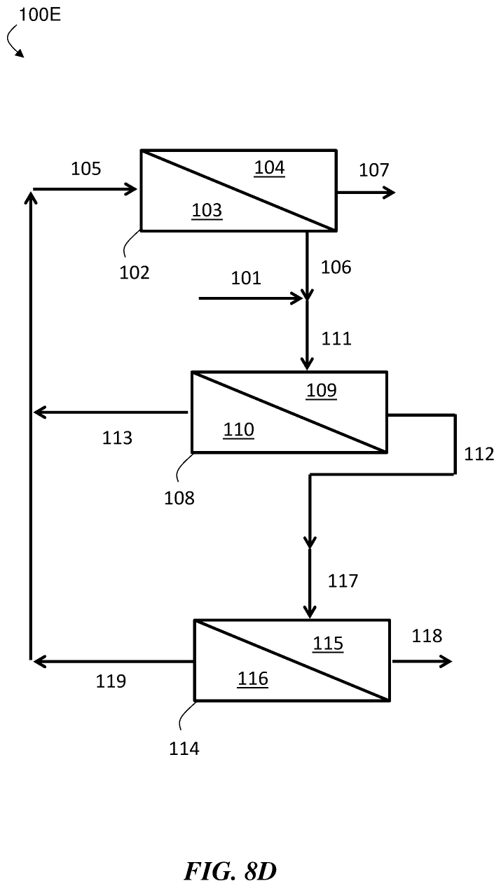

In some embodiments, the second membrane separator retentate inlet stream (which may comprise at least a portion (e.g., at least 5 wt %, at least 10 wt %, at least 20 wt %, at least 50 wt %, at least 80 wt %, at least 90 wt %, at least 95 wt %, at least 99 wt %, or more) of the first membrane separator retentate outlet stream, optionally with one or more other streams) is transported to a retentate side of the second membrane separator such that a second membrane separator retentate outlet stream exits the retentate side of the second membrane separator, the second membrane separator retentate outlet stream having an osmotic pressure that is greater (e.g., by a factor of at least 1.03, at least 1.035, at least 1.05, at least 1.10, at least 1.25, and/or up to 1.40, up to 1.50, up to 2, up to 3, up to 4, up to 5 or greater) than an osmotic pressure of the second membrane separator retentate inlet stream. In some embodiments, the second membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the feed stream, optionally with one or more other streams. Having the retentate side of the second membrane separator receive at least a portion of the feed stream may facilitate the treatment of feed streams having a higher osmotic pressure than in some instances in which the feed stream is fed to the retentate side of the first membrane separator. The second membrane separator inlet stream comprising at least a portion of the feed stream (and in some instances, at least a portion of the first membrane separator retentate outlet stream) may be transported to the retentate side of the second membrane separator such that the second membrane separator retentate outlet stream exits the retentate side of the second membrane separator, the second membrane separator retentate outlet stream having an osmotic pressure that is greater (e.g., by a factor of at least 1.03, at least 1.035, at least 1.05, at least 1.10, at least 1.25, and/or up to 1.40, up to 1.50, up to 2, up to 3, up to 4, up to 5, or greater) than an osmotic pressure of the second membrane separator retentate inlet stream. For example, referring again to FIGS. 2-3D and 8A-9C, second membrane separator 108 may comprise at least one semi-permeable membrane defining retentate side 109 and permeate side 110, and second membrane separator retentate inlet stream 111 may be transported to retentate side 109 such that second membrane separator retentate outlet stream 112 exits retentate side 109. In some embodiments, such as those shown in FIGS. 2-3D and 8A-9C, second membrane separator retentate inlet stream 111 comprises at least a portion of first membrane separator retentate outlet stream 106. In some embodiments, such as those shown in FIGS. 8A-8D, second membrane separator retentate inlet stream 111 comprises at least a portion of feed stream 101. This step may be performed such that second membrane separator retentate outlet stream 112 has an osmotic pressure that is greater than an osmotic pressure of second membrane separator retentate inlet stream 111, according to some embodiments. For example, this step may be performed such that second membrane separator retentate outlet stream 112 has a concentration of the solute that is increased with respect to the concentration of second membrane separator retentate inlet stream 111 (e.g., by a factor of at least 1.03, at least 1.035, at least 1.05, at least 1.10, at least 1.25, and/or up to 1.40, up to 1.50, up to 2, up to 3, up to 4, up to 5 or greater). In some embodiments, a hydraulic pressure is applied (e.g., to facilitate transport of liquid and/or solute from the retentate side to the permeate side). In some embodiments, the system is operated such that the second membrane separator retentate inlet stream has a hydraulic pressure that is at least 50%, at least 75%, at least 90%, at least 95%, or more of the pressure of the first membrane separator retentate inlet stream. In some embodiments, the system is operated such that the second membrane separator retentate inlet stream has a hydraulic pressure of at least 200 psi (at least 1.38×10³ kPa), at least 500 psi (at least 3.45×10³ kPa), at least 750 psi (at least 5.17×10³ kPa), at least 1000 psi (at least 6.90×10³ kPa), and/or up to 1500 psi (up to 1.03×10⁴ kPa), up to 2000 psi (up to 1.38×10⁴ kPa), or more.

In some embodiments, at least a portion (e.g., at least 5 wt %, at least 10 wt %, at least 20 wt %, at least 50 wt %, at least 80 wt %, and/or up to 90 wt %, up to 95 wt %, up to 99 wt %, or more) of liquid from the second membrane separator retentate inlet stream is transported from the retentate side of the second membrane separator, through a semi-permeable membrane of the second membrane separator, to a permeate side of the second membrane separator. Referring again to FIGS. 2-3D and 8A-9C, for example, at least a portion of liquid from second membrane separator retentate inlet stream 111 may be transported from retentate side 109, through a semi-permeable membrane, to permeate side 110. Liquid transported from the retentate side to the permeate side of the second membrane separator may form some (e.g., at least 5 wt %, at least 10 wt %, at least 20 wt %, at least 50 wt %, at least 80 wt %, at least 90 wt %, at least 95 wt %, at least 99 wt %, or more) or all of the liquid of a second membrane separator permeate outlet stream (e.g., second membrane separator permeate outlet stream 113 in FIGS. 2-3D and 8A-9C).

In some embodiments, at least a portion (e.g., at least 5 wt %, at least 10 wt %, at least 20 wt %, at least 50 wt %, at least 80 wt %, and/or up to 85%, up to 90%, or more) of solute from the second membrane separator retentate inlet stream is transported from the retentate side of the second membrane separator, through the semi-permeable membrane of the second membrane separator, to the permeate side of the second membrane separator. Referring again to FIGS. 2-3D and 8A-9C, for example, at least a portion of solute from second membrane separator retentate inlet stream 111 may be transported from retentate side 109, through a semi-permeable membrane, to permeate side 110. Solute transported from the retentate side to the permeate side of the second membrane separator may form some (e.g., at least 5 wt %, at least 10 wt %, at least 20 wt %, at least 50 wt %, at least 80 wt %, at least 90 wt %, at least 95 wt %, at least 99 wt %, or more) or all of any solute present in the second membrane separator permeate outlet stream (e.g., second membrane separator permeate outlet stream 113 in FIGS. 2-3D and 8A-9C). The amount of solute that may pass through the semi-permeable membrane of the second membrane separator may depend on any of a variety of parameters such as the solute concentration in the second membrane separator retentate inlet stream, the solute permeability of the membrane, the water permeability of the membrane, the temperature, and/or a magnitude of hydraulic pressure of the second membrane separator retentate inlet stream. In some embodiments, at least a portion of liquid and solute from the second membrane separator retentate inlet stream is transported from the retentate side of the second membrane separator, through the semi-permeable membrane of the second membrane separator, to the permeate side of the second membrane separator.

Some embodiments comprise transporting a third membrane separator retentate inlet stream to a retentate side of a third membrane separator. The third membrane separator may comprise at least one semi-permeable membrane defining a permeate side of the third membrane separator and a retentate side of the third membrane separator.

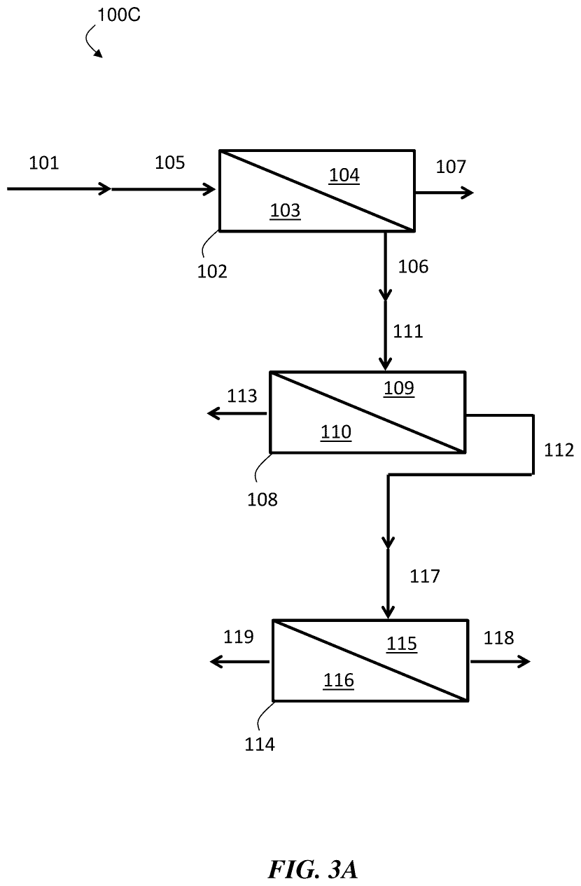

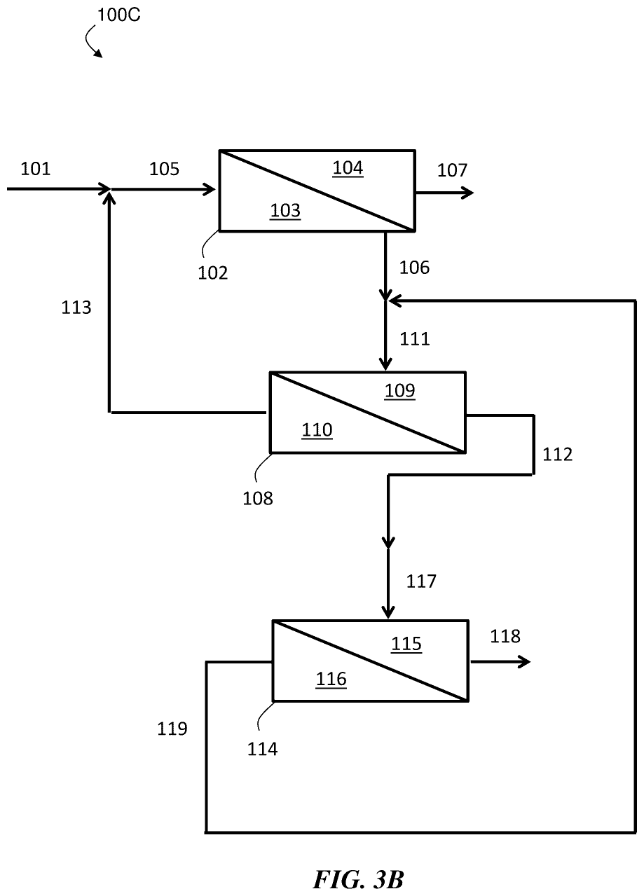

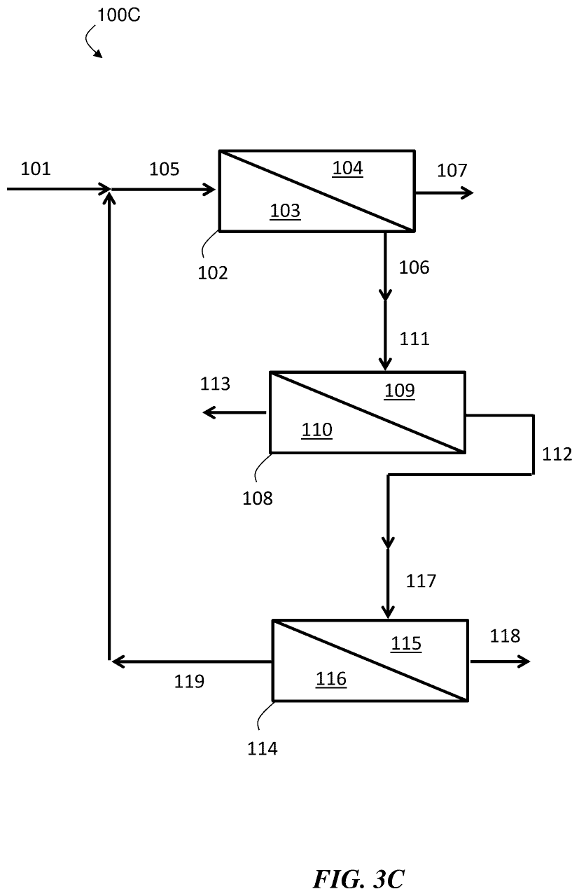

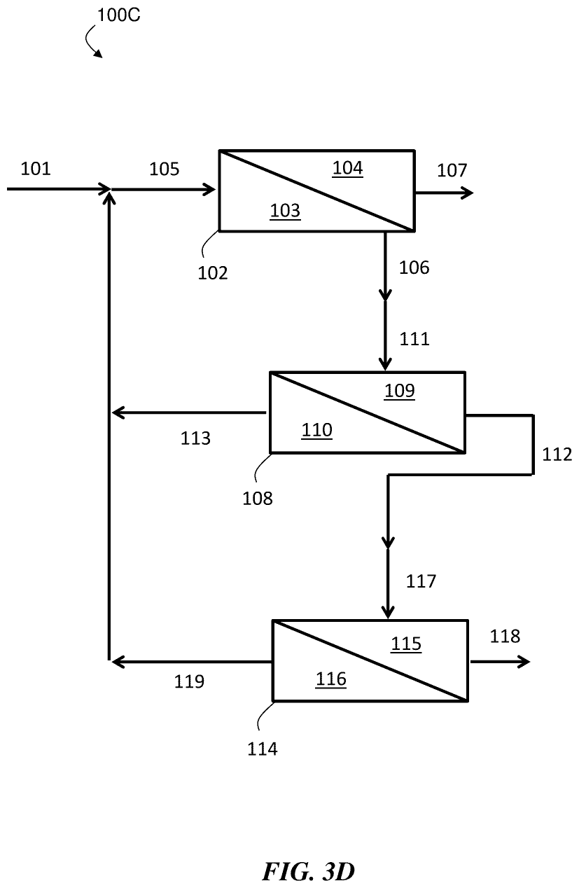

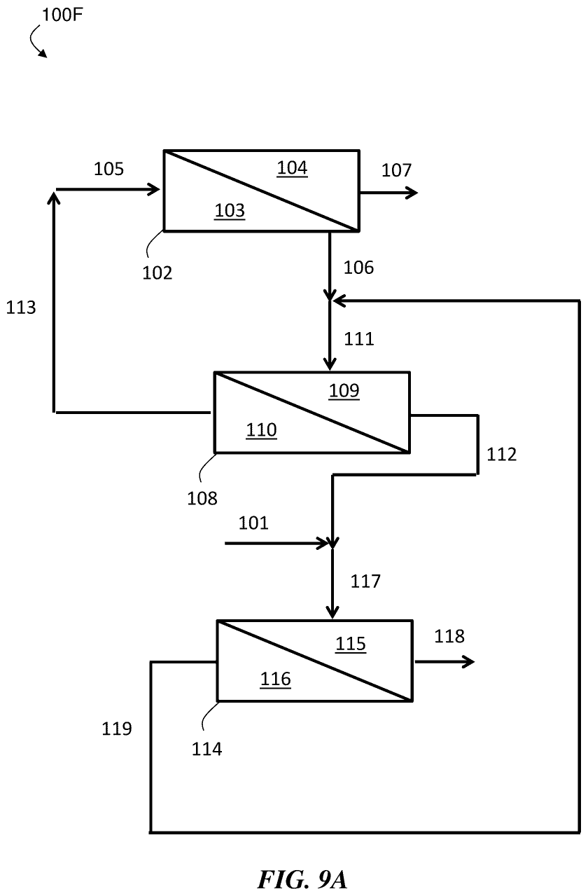

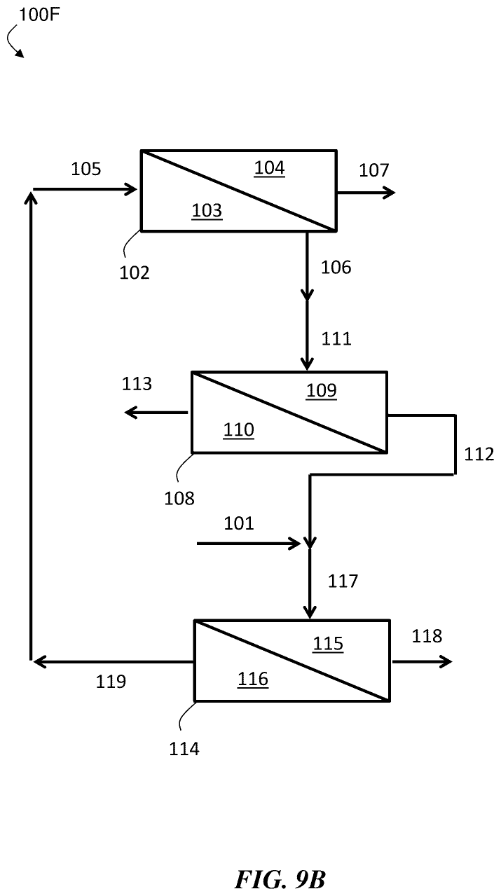

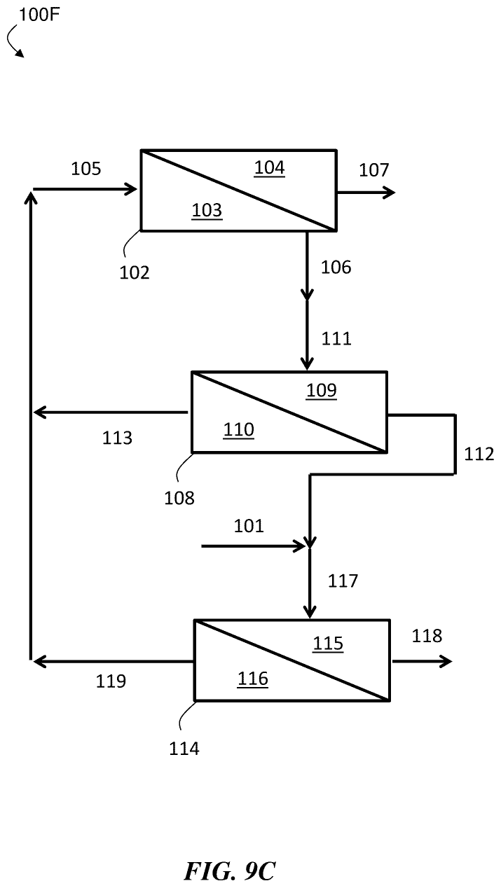

In some embodiments, the third membrane separator retentate inlet stream (which may comprise at least a portion (e.g., at least 5 wt %, at least 10 wt %, at least 20 wt %, at least 50 wt %, at least 80 wt %, at least 90 wt %, at least 95 wt %, at least 99 wt %, or more) of the second membrane separator retentate outlet stream, optionally with one or more other streams) is transported to a retentate side of the third membrane separator such that a third membrane separator retentate outlet stream exits the retentate side of the third membrane separator, the third membrane separator retentate outlet stream having an osmotic pressure that is greater (e.g., by a factor of at least 1.03, at least 1.035, at least 1.05, at least 1.10, at least 1.25, and/or up to 1.40, up to 1.50, up to 2, up to 3, up to 4, up to 5 or greater) than an osmotic pressure of the third membrane separator retentate inlet stream. In some embodiments, the third membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the feed stream, optionally with one or more other streams. Having the retentate side of the third membrane separator receive at least a portion of the feed stream may facilitate the treatment of feed streams having a higher osmotic pressure than in some instances in which the feed stream is fed to the retentate side of the first membrane separator. The third membrane separator inlet stream comprising at least a portion of the feed stream (and in some instances, at least a portion of the second membrane separator retentate outlet stream) may be transported to the retentate side of the third membrane separator such that the third membrane separator retentate outlet stream exits the retentate side of the third membrane separator, the third membrane separator retentate outlet stream having an osmotic pressure that is greater (e.g., by a factor of at least 1.03, at least 1.035, at least 1.05, at least 1.10, at least 1.25, and/or up to 1.40, up to 1.50, up to 2, up to 3, up to 4, up to 5 or greater) than an osmotic pressure of the third membrane separator retentate inlet stream. For example, in the embodiments shown in FIGS. 3A-3D and 8B-9C, third membrane separator 114 may comprise at least one semi-permeable membrane defining retentate side 115 and permeate side 116, and third membrane separator retentate inlet stream 117 may be transported to retentate side 115 such that third membrane separator retentate outlet stream 118 exits retentate side 115. In some embodiments, such as those shown in FIGS. 3A-3D and 8A-9C, third membrane separator retentate inlet stream 117 comprises at least a portion of second membrane separator retentate outlet stream 112. In some embodiments, such as those shown in FIGS. 9A-9C, third membrane separator retentate inlet stream 117 comprises at least a portion of feed stream 101. This step may be performed such that third membrane separator retentate outlet stream 118 has an osmotic pressure that is greater than an osmotic pressure of third membrane separator retentate inlet stream 117, according to some embodiments. For example, this step may be performed such that third membrane separator retentate outlet stream 118 has a concentration of the solute that is increased with respect to the concentration of third membrane separator retentate inlet stream 117 greater (e.g., by a factor of at least 1.03, at least 1.035, at least 1.05, at least 1.10, at least 1.25, and/or up to 1.40, up to 1.50, up to 2, up to 3, up to 4, up to 5 or greater). In some embodiments, a hydraulic pressure is applied (e.g., to facilitate transport of liquid and/or solute from the retentate side to the permeate side). In some embodiments, the system is operated such that the third membrane separator retentate inlet stream has a hydraulic pressure that is at least 50%, at least 75%, at least 90%, at least 95%, or more of the pressure of the second membrane separator retentate inlet stream. In some embodiments, the system is operated such that the third membrane separator retentate inlet stream has a hydraulic pressure of at least 200 psi (at least 1.38×10³ kPa), at least 500 psi (at least 3.45×10³ kPa), at least 750 psi (at least 5.17×10³ kPa), at least 1000 psi (at least 6.90×10³ kPa), and/or up to 1500 psi (up to 1.03×10⁴ kPa), up to 2000 psi (up to 1.38×10⁴ kPa), or more.

In some embodiments, at least a portion (e.g., at least 5 wt %, at least 10 wt %, at least 20 wt %, at least 50 wt %, at least 80 wt %, and/or up to 90 wt %, up to 95 wt %, up to 99 wt %, or more) of liquid from the third membrane separator retentate inlet stream is transported from the retentate side of the third membrane separator, through a semi-permeable membrane of the third membrane separator, to a permeate side of the third membrane separator. Referring again to FIGS. 3A-3D and 8B-9C, for example, at least a portion of liquid from third membrane separator retentate inlet stream 117 may be transported from retentate side 115, through a semi-permeable membrane, to permeate side 116. Liquid transported from the retentate side to the permeate side of the third membrane separator may form some (e.g., at least 5 wt %, at least 10 wt %, at least 20 wt %, at least 50 wt %, at least 80 wt %, at least 90 wt %, at least 95 wt %, at least 99 wt %, or more) or all of the liquid of a third membrane separator permeate outlet stream (e.g., third membrane separator permeate outlet stream 119 in FIGS. 3A-3D and 8B-9C).

In some embodiments, at least a portion (e.g., at least 5 wt %, at least 10 wt %, at least 20 wt %, at least 50 wt %, at least 80 wt %, and/or up to 85%, up to 90%, or more) of solute from the third membrane separator retentate inlet stream is transported from the retentate side of the third membrane separator, through the semi-permeable membrane of the third membrane separator, to the permeate side of the third membrane separator. Referring again to FIGS. 3A-3D and 8B-9C, for example, at least a portion of solute from third membrane separator retentate inlet stream 117 may be transported from retentate side 115, through a semi-permeable membrane, to permeate side 116. Solute transported from the retentate side to the permeate side of the third membrane separator may form some (e.g., at least 5 wt %, at least 10 wt %, at least 20 wt %, at least 50 wt %, at least 80 wt %, at least 90 wt %, at least 95 wt %, at least 99 wt %, or more) or all of any solute present in the third membrane separator permeate outlet stream (e.g., third membrane separator permeate outlet stream 119 in FIGS. 3A-3D and 8B-9C). The amount of solute that may pass through the semi-permeable membrane of the third membrane separator may depend on any of a variety of parameters such as the solute concentration in the third membrane separator retentate inlet stream, the solute permeability of the membrane, the water permeability of the membrane, the temperature, and/or a magnitude of hydraulic pressure of the third membrane separator retentate inlet stream. In some embodiments, at least a portion of liquid and solute from the third membrane separator retentate inlet stream is transported from the retentate side of the third membrane separator, through the semi-permeable membrane of the third membrane separator, to the permeate side of the third membrane separator.

While FIGS. 1-3D and 8A-9C show one, two, or three membrane separators, it should be understood that a different number of membrane separators can be employed in the system and used in the methods of this disclosure. For example, a system comprising a plurality of membrane separators may have at least one, at least two, at least three, at least four, at least five, at least ten, and least twenty, or more membrane separators configured as described in this disclosure.

In some embodiments, at least a portion of a stream exiting one or more membrane separator is recirculated and fed back into a membrane separator (e.g., an upstream membrane separator). Such recycle processes may allow for relatively high amounts of liquid to be removed by the system (in some instances using fewer system components) and/or for relatively high recovery rates and/or efficiencies compared to some embodiments in which no such recycle occurs.

As one example of a recycle process, in some embodiments the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) or all of the second membrane separator permeate outlet stream. The first membrane separator retentate inlet stream may comprise at least a portion of the second membrane separator permeate outlet stream during at least a period of time (e.g., an entirety or a subset of time) during operation of the first membrane separator and second membrane separator as part of the methods described in this disclosure. As an illustrative example, the embodiments shown in FIG. 3B and FIG. 3D and FIGS. 8B, 8D, 9A, and 9C show at least a portion of second membrane separator permeate outlet stream 113 being transported back to first membrane separator retentate inlet stream 105. Second membrane separator permeate outlet stream 113 may be combined with feed stream 101 to form at least part of first membrane separator retentate inlet stream 105.

As another example of a recycle process, in some embodiments in which a third membrane separator is employed, the second membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) or all of the third membrane separator permeate outlet stream. The second membrane separator retentate inlet stream may comprise at least a portion of the third membrane separator permeate outlet stream during at least a period of time (e.g., an entirety or a subset of time) during operation of the first membrane separator, the second membrane separator, and/or the third membrane separator as part of the methods described in this disclosure. As an illustrative example, the embodiment shown in FIG. 3B shows at least a portion of third membrane separator permeate outlet stream 119 being transported back to second membrane separator retentate inlet stream 111. FIGS. 8B and 9A similarly show at least a portion of third membrane separator permeate outlet stream 119 being transported back to second membrane separator retentate inlet stream 111. Third membrane separator permeate outlet stream 119 may be combined with first membrane separator retentate outlet stream 106 to form at least part of second membrane separator retentate inlet stream 111.

Other recycle processes may also be employed. For example, in some embodiments, the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) or all of the third membrane separator permeate outlet stream. Such a process may occur in embodiments in which the retentate side of the first membrane separator is fluidically connected to the permeate side of the third membrane separator. As an illustrative example, the embodiments shown in FIGS. 3C-3D and FIGS. 8C, 8D, 9B, and 9C show at least a portion of third membrane separator permeate outlet stream 119 being transported back to first membrane separator retentate inlet stream 105. Third membrane separator permeate outlet stream 119 may be combined with feed stream 101 to form at least part of first membrane separator retentate inlet stream 105.

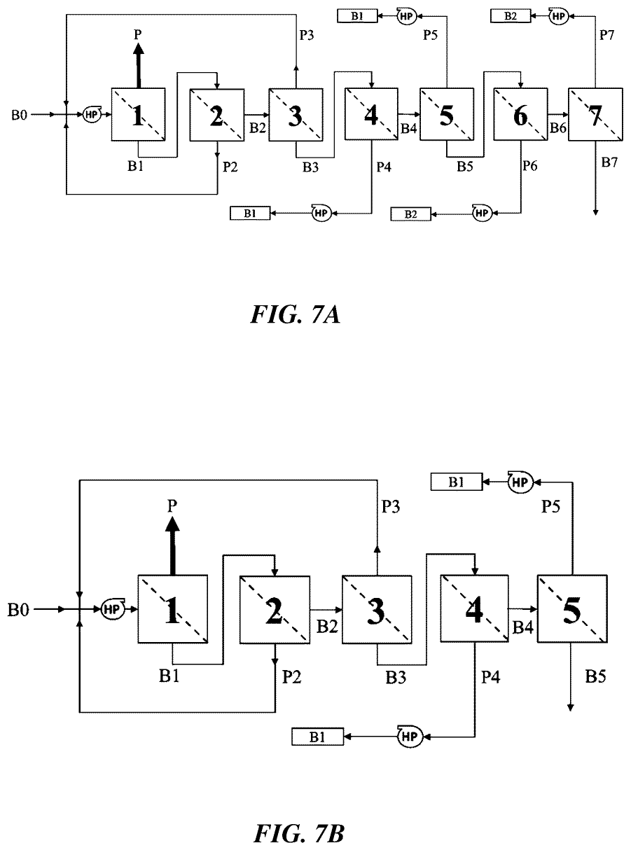

In some embodiments, the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) or all of the second membrane separator permeate outlet stream and also at least a portion (e.g., at least 5 wt %, at least 10 wt %, at least 20 wt %, at least 50 wt %, at least 80 wt %, at least 90 wt %, at least 95 wt %, at least 99 wt %) or all of the third membrane separator permeate outlet stream. Such a process may occur in embodiments in which the retentate side of the first membrane separator is fluidically connected to the permeate side of the second membrane separator and the permeate side of the third membrane separator. As an illustrative example, the embodiment shown in FIG. 3D shows at least a portion of second membrane separator permeate outlet stream 113 and at least a portion of third membrane separator permeate outlet stream 119 being transported back to first membrane separator retentate inlet stream 105. FIGS. 8D and 9C similarly show at least a portion of second membrane separator permeate outlet stream 113 and at least a portion of third membrane separator permeate outlet stream 119 being transported back to first membrane separator retentate inlet stream 105. Second membrane separator permeate outlet stream 113 and third membrane separator permeate outlet stream 119 may be combined with feed stream 101 to form at least part of first membrane separator retentate inlet stream 105. The embodiment shown in FIG. 7B shows another example of such connectivity and operation, where stage 1 corresponds to the first membrane separator, stage 2 corresponds to the second membrane separator, and stage 3 corresponds to the third membrane separator. This embodiment is described in more detail below.

In some embodiments, the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) of the feed stream (e.g., feed stream 101) and at least a portion (e.g., at least 5 wt %, at least 10 wt %, at least 20 wt %, at least 50 wt %, at least 80 wt %, at least 90 wt %, at least 95 wt %, at least 99 wt %) of an upstream membrane separator retentate outlet stream. The term “upstream” in “upstream membrane separator” is used for convenience and refers to the direction of flow of the liquid transported into and out of the retentate side of the first membrane separator. The upstream membrane separator may have a retentate side of at least one semi-permeable membrane. In some such embodiments, the retentate side of the upstream separator may receive an upstream membrane separator retentate inlet stream (e.g., by having the retentate side of the first membrane separator be fluidically connected to the retentate side of the upstream membrane separator). Referring to FIG. 2B, system 100B may further comprise upstream membrane separator 120. Upstream membrane separator 120 may comprise at least one semi-permeable membrane defining retentate side 121 and permeate side 122, and upstream membrane separator retentate inlet stream 123 may be transported to retentate side 121 such that upstream membrane separator retentate outlet stream 124 exits retentate side 121. This step may be performed such that upstream membrane separator retentate outlet stream 124 has an osmotic pressure that is greater than an osmotic pressure of upstream membrane separator retentate inlet stream 123, according to some embodiments. At least a portion of upstream membrane separator retentate outlet stream 124 may be combined with at least a portion of feed stream 101 to form some or all of first membrane separator retentate inlet stream 105, which is transported to retentate side 103 of first membrane separator 102. Liquid transported from the retentate side to the permeate side of the upstream membrane separator may form some or all of an upstream membrane separator permeate outlet stream (e.g., upstream membrane separator permeate outlet stream 125 in FIG. 2B), which may be discharged from the system (e.g., as relatively pure liquid such as relatively pure water).

The upstream separator retentate inlet stream may comprise at least a portion of one or more streams mentioned elsewhere in this disclosure. For example, in some embodiments, the upstream membrane separator retentate inlet stream comprises at least a portion of the first membrane separator permeate outlet stream, at least a portion of the second membrane separator permeate outlet stream, and/or at least a portion of the third membrane separator outlet stream (e.g., by having the retentate side of the upstream membrane separator be fluidically connected to the permeate side of the first membrane separator, the permeate side of the second membrane separator, and/or the permeate side of the third membrane separator).

In some embodiments, the upstream membrane separator and/or at least one semi-permeable of the upstream separator differs from first membrane separator and/or at least one semi-permeable membrane of the first membrane separator in one or more of the parameters discussed elsewhere in this disclosure. For example, the upstream membrane separator may have a different (e.g., lower) salt passage percentage at standard conditions, a different (e.g., lower) solute permeability, a different (e.g., higher) rejection for a solute, and/or a different total membrane surface area as compared to the first membrane separator. In some embodiments, the at least one semi-permeable membrane of the upstream membrane separator has a different (e.g., lower) average molecular weight cutoff (MWCO) as compared to the at least one semi-permeable membrane of the first membrane separator.

In some embodiments, the first membrane separator retentate inlet stream does not comprise any portion of an upstream membrane separator retentate outlet stream, or less than 10 wt %, less than 5 wt %, less than 2 wt %, less than 1 wt %, less than 0.1 wt %, or less of the first membrane separator inlet stream is produced by an upstream membrane separator retentate outlet stream.

As mentioned above, each membrane separator of the system may comprise at least one semi-permeable membrane. In general, a semi-permeable membrane is a barrier that allows some components of a mixture to pass through while blocking at least some of other components (e.g., blocking all of another component, or reducing the relative rate of permeation of another component). For example, a semi-permeable membrane may block some molecules in a liquid solution from passing through while allowing others to pass through. In some instances, a semi-permeable membrane blocks some molecules and permits other molecules to pass through based on their molecular weight and/or charge. As noted above, a semi-permeable membrane can be used for osmotic processes. For example, the semi-permeable membrane may be an osmotic membrane. An osmotic membrane may be capable of producing an osmotic pressure difference between solutions on either side of the membrane upon application of a hydraulic pressure difference across the two sides of the membrane. For example, if an osmotic membrane is placed between two solutions of identical composition such that there is initially no osmotic pressure difference across the membrane, application of a hydraulic pressure difference across the osmotic membrane may allow for transport of components from one side of the membrane to the other such that an osmotic pressure difference across the two sides of the membrane is established. Semi-permeable membranes may also be used for nanofiltration processes. Semi-permeable membranes may be configured for osmotic processes, nanofiltration processes, and/or processes in which separation is achieved based on a combination of nanofiltration and osmotic mechanisms (e.g., based on, for example, the molecular weight cutoff of the membranes, pore sizes of the membranes, the nature of the mixtures to which they are exposed, and a magnitude of applied hydraulic pressure).

The semi-permeable membranes can comprise, for example, a metal, a ceramic, a polymer (e.g., polyamides, polyethylenes, polyesters, poly(tetrafluoroethylene), polysulfones, polycarbonates, polypropylenes, poly(acrylates)), and/or composites or other combinations of these. The semi-permeable membranes generally allow for the preferential transport of liquid (e.g., a solvent such as water) through the membrane, where liquid is capable of being transmitted through the membrane while some or all of the solute (e.g., solubilized species such as solubilized ions) are inhibited from being transported through the membrane. Examples of commercially available osmotic membranes that can be used in association with certain of the embodiments described herein include, but are not limited to, those commercially available from Dow Water and Process Solutions (e.g., FilmTec™ membranes), Hydranautics, GE Osmonics, Toray Membrane, Suez, and Microdyn among others known to those of ordinary skill in the art.

In some embodiments, the semi-permeable membrane(s) of the first membrane separator, the second membrane separator, and/or the third membrane separator has an average pore size of greater than or equal to 0.0001 microns, greater than or equal to 0.001 microns, greater than or equal to 0.002, microns or greater. In some embodiments, the semi-permeable membrane of the first membrane separator, the second membrane separator, and/or the third membrane separator has an average pore size of less than or equal to 0.01 microns, less than or equal to 0.005 microns, or less. Combinations of these ranges (e.g., greater than or equal to 0.0001 microns and less than or equal to 0.01 microns) are possible.

In some embodiments, the semi-permeable membrane(s) of the second membrane separator has an average pore size that is greater than that of the semi-permeable membrane(s) of the first membrane separator (e.g., by a factor of at least 1.05, at least 1.1, at least 1.2, at least 1.5, at least 2, at least 3, at least 5, or more). In some embodiments, the semi-permeable membrane(s) of the third membrane separator has an average pore size that is greater than that of the semi-permeable membrane(s) of the second membrane separator (e.g., by a factor of at least 1.05, at least 1.1, at least 1.2, at least 1.5, at least 2, at least 3, at least 5, or more). The average pore size of the semi-permeable membrane may affect any of a variety of the parameters discussed below, such as solute permeability, water permeability, salt passage, rejection, and/or recovery. Average pore size can be determined, for example, using mercury intrusion porosimetry.

In some embodiments, the semi-permeable membrane of a membrane separator of this disclosure has an average molecular weight cutoff (MWCO) that is sufficiently high such that a desired amount of liquid and/or solute (and/or type of solute) can pass through during operation of the system. In some embodiments, the semi-permeable membrane(s) of the first membrane separator, the second membrane separator, and/or the third membrane separator has an average MWCO of greater than or equal to 50 Daltons, greater than or equal to 75 Daltons, greater than or equal to 100 Daltons, greater than or equal to 150 Daltons, or greater. In some embodiments, the semi-permeable membrane of a membrane separator of this disclosure has an average molecular weight cutoff (MWCO) that is sufficiently low such that a desired amount of solute (and/or type of solute) is rejected such that an effective separation is performed. In some embodiments, the semi-permeable membrane(s) of the first membrane separator, the second membrane separator, and/or the third membrane separator has an average MWCO of less than or equal to 400 Daltons, less than or equal to 300 Daltons, less than or equal to 250 Daltons, less than or equal to 200 Daltons, or less. Combinations of these ranges (e.g., greater than or equal to 50 Daltons and less than or equal to 400 Daltons, greater than or equal to 50 Daltons and less than or equal to 250 Daltons) are possible. The average MWCO of a membrane refers to the lowest molecular weight solute in which 90% of the solute is retained by the membrane.

In some embodiments, the semi-permeable membrane(s) of the second membrane separator has an average MWCO that is greater than that of the semi-permeable membrane(s) of the first membrane separator (e.g., by a factor of at least 1.05, at least 1.1, at least 1.2, at least 1.5, at least 2, at least 3, at least 5, and/or up to 10, up to 20, or more). In some embodiments, the semi-permeable membrane(s) of the third membrane separator has an average MWCO that is greater than that of the semi-permeable membrane(s) of the second membrane separator (e.g., by a factor of at least 1.05, at least 1.1, at least 1.2, at least 1.5, at least 2, at least 3, at least 5, and/or up to 10, up to 20, or more). The average MWCO of the semi-permeable membrane may affect any of a variety of the parameters discussed below, such as solute permeability, salt passage, rejection, and/or recovery.

Each membrane separator has a total membrane surface area, which corresponds to the sum of the surface areas of each semi-permeable membrane of the membrane separator. For example, if the membrane separator comprises only one semi-permeable membrane, then that membrane separator has a total membrane surface area equal to the surface area of the one semi-permeable membrane. As another example, if the membrane separator has two and only two semi-permeable membranes, then that membrane separator has a total membrane surface area equal to the sum of the surface areas of those two semi-permeable membranes.

In some embodiments, the first membrane separator has a total membrane surface area that is different than the total membrane surface area of the second membrane separator. For example, the first membrane separator may have a total membrane surface area that is larger than the total membrane surface area of the second membrane separator (e.g., by a factor of at least 1.05, at least 1.1, at least 1.2, at least 1.5, at least 2, at least 3, at least 5, and/or up to 10, up to 20, or more). In some embodiments, the second membrane separator has a total membrane surface area that is larger than the total membrane surface area of the first membrane separator (e.g., by a factor of at least 1.05, at least 1.1, at least 1.2, at least 1.5, at least 2, at least 3, at least 5, and/or up to 10, up to 20, or more). These ranges may be satisfied during some or all of the operation of the methods described in this disclosure.

In some embodiments in which a third membrane separator is present, the second membrane separator has a total membrane surface area that is different than the total membrane surface area of the third membrane separator. For example, the second membrane separator may have a total membrane surface area that is larger than the total membrane surface area of the third membrane separator (e.g., by a factor of at least 1.05, at least 1.1, at least 1.2, at least 1.5, at least 2, at least 3, at least 5, and/or up to 10, up to 20, or more). In some embodiments, the third membrane separator has a total membrane surface area that is larger than the total membrane surface area of the second membrane separator (e.g., by a factor of at least 1.05, at least 1.1, at least 1.2, at least 1.5, at least 2, at least 3, at least 5, and/or up to 10, up to 20, or more). However, in some embodiments, the second membrane separator has a total membrane surface area that is relatively similar to the total membrane surface area of the third membrane separator. For example, in some embodiments, the total membrane surface area of the second membrane separator is within 10%, within 5%, within 2%, within 1% or less of the total membrane surface area of the third membrane separator. These ranges may be satisfied during some or all of the operation of the methods described in this disclosure.

In some embodiments in which a third membrane separator is present, the first membrane separator has a total membrane surface area that is different than the total membrane surface area of the third membrane separator. For example, the first membrane separator may have a total membrane surface area that is larger than the total membrane surface area of the third membrane separator (e.g., by a factor of at least 1.05, at least 1.1, at least 1.2, at least 1.5, at least 2, at least 3, at least 5, and/or up to 10, up to 20, or more). In some embodiments, the third membrane separator has a total membrane surface area that is larger than the total membrane surface area of the first membrane separator (e.g., by a factor of at least 1.05, at least 1.1, at least 1.2, at least 1.5, at least 2, at least 3, at least 5, and/or up to 10, up to 20, or more). These ranges may be satisfied during some or all of the operation of the methods described in this disclosure.

In certain embodiments, the total membrane surface area for one or more membrane separators (e.g., the first membrane separator, the second membrane separator) is changed (increased or decreased) during operation of the system. Changing the amount of membrane surface area that is employed in one or more membrane separators can, according to certain embodiments, allow one to advantageously control certain operational parameters (e.g., solute enhancement factor, mass flow ratio) and/or relationships thereof between membrane separators, which can enhance efficiency of operation. In some embodiments, the total membrane surface area for one or more separators (e.g., the first membrane separator, the second membrane separator, and/or the third membrane separator) is changed at least in part due to a measurement of a value of at least one parameter of a stream (e.g., the feed steam), such as the salinity and/or solute composition of the stream.

In some embodiments, the total membrane surface area of one or more membrane separators is increased or decreased as a function of time during operation of the methods of this disclosure. For example, in some embodiments, additional or less flow through the first membrane separator, second membrane separator, and/or third membrane separator may be activated by introducing additional semi-permeable membrane(s) to or removing semi-permeable membrane(s) from the first membrane separator, second membrane separator, and/or third membrane separator as operation progresses.

In some embodiments, the total membrane surface area of one or more membrane separators (e.g., the first membrane separator, the second membrane separator, the third membrane separator) is increased or decreased as a function of time during operation of the methods of this disclosure by at least 5%, at least 10%, or at least 25%. Stated another way, in some embodiments, there is at least one point in time at which the total membrane surface area of one or more membrane separators is at least 5% (or at least 10%, or at least 25%) greater or less than the total membrane surface area that was present within the one or more membrane separator during at least one earlier point in time during operation of the method. A person of ordinary skill in the art would understand that a percentage increase or percentage decrease is measured relative to the initial value. To illustrate, if the total membrane surface area within a membrane separator is originally at 100 cm², and the total membrane surface area within the membrane separator is subsequently increased to 106 cm², that would correspond to an increase of 6% (because the difference, 6 cm², is 6% of the original value of 100 cm²).

The solute permeability of each membrane separator may be chosen based on any of a variety of design criteria such as desired purity of permeate, desired hydraulic pressure to be used, and nature of incoming influent (e.g., solute concentration of incoming influent). The solute permeability of a membrane separator can be calculated from the solute flux through the membrane and the respective concentrations of solute on either side using equation [3] below:

J_{S}=B(C_{R}−C_{P}) [3]

In the above equation, Jₛ represents the ion flux, C_{R} represents the concentration of solute on the retentate side of the membrane, C_{P} represents the concentration of solute on the permeate side of the membrane, and B represents the solute permeability. Solute permeability is dependent on the species of solute in the retentate inlet stream and the concentrations on either side of the membrane.

In some embodiments, the solute permeabilities of the first membrane separator and the second membrane separator (and, if present the third membrane separator) during operation of the method are chosen to afford good, consistent performance across all membrane separators by accounting for differences in concentrations of their respective retentate inlet streams. In some embodiments, the solute permeability of the first membrane separator during the step of transporting the first membrane separator retentate inlet stream to the retentate side of the first membrane separator is different than the solute permeability of the second membrane separator during the step of transporting the second membrane separator retentate inlet stream to the retentate side of the second membrane separator. The difference in solute permeabilities between the first membrane separator and the second membrane separator may be due, at least in part, to use of different semi-permeable membranes in the first and second membrane separators (e.g., having different pore sizes, MWCOs, and/or surface chemistries). In some embodiments, the solute permeability of the first membrane separator during the step of transporting the first membrane separator retentate inlet stream to the retentate side of the first membrane separator and the solute permeability of the second membrane separator during the step of transporting the second membrane separator retentate inlet stream to the retentate side of the second membrane separator are at least 5% different, at least 10% different, at least 20% different, at least 50% different, and/or up to 100% different or more different from each other. In some embodiments, the solute permeability of the second membrane separator during the step of transporting the second membrane separator retentate inlet stream to the retentate side of the second membrane separator is greater than the solute permeability of the first membrane separator during the step of transporting the first membrane separator retentate inlet stream to the retentate side of the first membrane separator (e.g., by a factor of at least 1.05, at least 1.1, at least 1.2, at least 1.5, at least, 2, at least, 3, at least 5, or more). In some embodiments, the first membrane separator has a solute permeability of 0 during operation of the first membrane separator. In this context, the solute permeability refers to the permeability of all total solute in the streams. However, in some embodiments, the relationships between permeabilities of the first and second membrane separators hold for one or more specific solute species described in this disclosure, such as solubilized NaCl and/or sulfate anions.

When calculating the percentage difference between two values (unless specified otherwise herein), the percentage calculation is made using the value that is larger in magnitude as the basis. To illustrate, if a first value is V₁, and a second value is V₂ (which is larger than V₁), the percentage difference (V_{% Diff}) between V₁ and V₂ would be calculated as:

$${V}_{\% Diff} = \frac{{V}_{2} - {V}_{1}}{{V}_{2}} \times 100 \% \qquad [ 4 ]$$

and the first and second values would be said to be within X % of each other if V_{% Diff} is X % or less, and the first and second values would be said to be at least X % different than each other if V_{% Diff} is X % or more.

Water permeability can be calculated from the water flux, pressure differential and osmotic differential, as shown below in equation 2:

J_{W}=A(ΔP−Δπ) [5]

In the above equation [5], J_{w} represents the flux of water through the membrane, ΔP represents the hydraulic pressure differential across the membrane, Δπ represents the osmotic pressure differential across the membrane, and A represents the water permeability.

The salt passage percentage at standard conditions of each membrane separator may be chosen based on any of a variety of design criteria such as desired purity of permeate, desired hydraulic pressure to be used, and nature of incoming influent (e.g., solute type and/or concentration of incoming influent). The salt passage percentage at standard conditions of a membrane separator is an intrinsic property of the separator based on the quantity of salt, as a percentage, which passes through the semi-permeable membrane(s) from the retentate side to the permeate side of the membrane separator under defined reference conditions. The salt passage percentage at standard conditions of a membrane separator can be determined using the standardized test described in ASTM D4516-19a.

In some embodiments, the salt passages at standard conditions of the first membrane separator and the second membrane separator (and, if present the third membrane separator) used in in the operation of the method are chosen to afford good, consistent performance across all membrane separators by accounting for differences in concentrations of their respective retentate inlet streams. In some embodiments, the salt passage percentage at standard conditions of the first membrane separator is different than the salt passage percentage at standard conditions of the second membrane separator. The difference in salt passages at standard conditions between the first membrane separator and the second membrane separator may be due, at least in part, to use of different semi-permeable membranes in the first and second membrane separators (e.g., having different pore sizes, MWCOs, and/or surface chemistries). In some embodiments, the salt passage percentage at standard conditions of the first membrane separator and the salt passage percentage at standard conditions of the second membrane separator are at least 5% different, at least 10% different, at least 20% different, at least 50% different, and/or up to 100% different or more different from each other. In some embodiments, the salt passage percentage at standard conditions of the second membrane separator is greater than the salt passage percentage at standard conditions of the first membrane separator (e.g., by a factor of at least 1.05, at least 1.1, at least 1.2, at least 1.5, at least, 2, at least, 3, at least 5, and/or up to 10, up to 20, or more). In some embodiments in which the system further comprises a third membrane separator, the salt passage percentage at standard conditions of the second membrane separator is different than the salt passage percentage at standard conditions of the third membrane separator. In some embodiments, the salt passage percentage at standard conditions of the second membrane separator and the salt passage percentage at standard conditions of the third membrane separator are at least 5% different, at least 10% different, at least 20% different, at least 50% different, and/or up to 100% different or more different from each other. In some embodiments, the salt passage percentage at standard conditions of the third membrane separator is greater than the salt passage percentage at standard conditions of the second membrane separator (e.g., by a factor of at least 1.05, at least 1.1, at least 1.2, at least 1.5, at least, 2, at least, 3, at least 5, and/or up to 10, up to 20, or more).

In some embodiments, the salt passage percentage at standard conditions of the first membrane separator, the second membrane separator, and/or the third membrane separator (if present) are independently greater than or equal to 0%, greater than or equal to 1%, greater than or equal to 2%, greater than or equal to 5%, greater than or equal to 10%, greater than or equal to 15%, greater than or equal to 20%, greater than or equal to 50%, greater than or equal to 75%, and/or up to 80%, up to 85%, up to 90%, or greater. In some embodiments, the first membrane separator has a relatively low salt passage percentage at standard conditions. Such a low salt passage percentage at standard conditions may be useful in embodiments in which the first membrane separator is operated as a high-rejection reverse osmosis separator. In some embodiments, the first membrane separator has a salt passage percentage at standard conditions of less than or equal to 10%, less than or equal to 5%, less than or equal to 2%, less than or equal to 1%, less than or equal to 0.1%, or less.

Intrinsic properties of a semi-permeable membrane such as salt passage percentage at standard conditions, pore size, and/or MWCO can be selected based on supplier specifications for commercially-obtained membranes, by controlling the synthesis of membranes, and/or by physically and/or chemically modifying existing membranes (e.g., commercially obtained membranes). As an example of the latter, in some embodiments, a set of identical membranes may be obtained commercially (or prepared synthetically). A first subset of the membranes may be used without further modification. A second subset may be subjected to a first type of modification procedure (e.g., chemical treatment) that enlarges the pores of the membranes and/or modifies the surface chemistry of the membranes in such a way that the intrinsic salt passage (salt passage percentage at standard conditions), average pore size, and/or MWCO is increased. A third subset of the membranes may be subjected to a second, different type of modification procedure (e.g., a different chemical treatment) that enlarges the pores of the membranes and/or modifies the surface chemistry of the membranes in such a way that the intrinsic salt passage, average pore size, and/or MWCO is increased to a greater extent than those of the second subset of membranes. In such a way, the first subset of membranes could be incorporated into the first membrane separator, the second subset of membranes into the second membrane separator, and the third subset of membranes into the third membrane separator, in accordance with some embodiments. Each of the first membrane separator, the second membrane separator, and the third membrane separator may then have a differing salt passage percentage at standard conditions and, in use, differing permeabilities, rejections, and recoveries.

In some embodiments, the semi-permeable membrane comprises cross-links. For example, the membrane may be a cross-linked polyamide membrane. In some embodiments, the semi-permeable membrane comprises an active layer which comprises the cross-links (e.g., a cross-linked polyamide active layer). One way in which a semi-permeable membrane of can be modified (e.g., such that the intrinsic salt passage, average pore size, and/or MWCO is increased) is via disruption of at least some (e.g., at least 0.01 mole percent (mol %), at least 0.1 mol %, at least 0.2 mol %, at least 0.5 mol %, at least 1 mol %, at least 2 mol %, at least 5 mol %, and/or up to 10 mol %, up to 20 mol %, or more) of the cross-links of the membrane. For example, cross-links (e.g., of polyamide chains) of the membrane may be disrupted via physical treatment (e.g., thermal treatment and/or mechanical disruption) and/or chemical treatment (e.g., via treatment with a chemical reagent and/or ultraviolet or visible light). Chemical treatment may result in chemical disruption (e.g., via breaking of chemical bonds due to a chemical reaction, breaking of noncovalent interactions such as hydrogen bonding) of at least some (e.g., at least 0.1 mole percent (mol %), at least 0.2 mol %, at least 0.5 mol %, at least 1 mol %, at least 2 mol %, at least 5 mol %, and/or up to 10 mol %, up to 20 mol %, or more) of the cross-links. In some embodiments in which the semi-permeable membrane comprises cross-links (e.g., as part of an active layer), the semi-permeable membrane comprises a cross-linked polymeric material derived from monomers. In some such embodiments, fewer than or equal to 99.9 mol % (e.g., fewer than or equal to 99 mol %, fewer than or equal to 98 mol %, fewer than or equal to 95 mol %, and/or as few as 90 mol %, as few as 80 mol %, or fewer) of the monomers participate in at least one crosslink (e.g., due at least in part to disruption such as chemical disruption).

One example of a way in which at least some cross-links may be disrupted is by treating at least a portion of the membrane with a chemical reagent tending to break covalent and/or noncovalent bonds within the cross-links of the membrane. In some embodiments, the chemical reagent comprises an oxidant. One example of a potential oxidant for use with at least some membranes (e.g., polyamide membranes) is hypochlorite (ClO⁻). The hypochlorite may be provided as a solution comprising sodium hypochlorite (NaClO). The cross-links of the membrane may be disrupted by exposing at least a portion of the membrane to the chemical reagent (e.g., an oxidant such as hypochlorite). The duration of the exposure and/or the amount of chemical reagent (e.g., concentration of reagent in a solution contacting the membrane) may be selected based on a desired extent of disruption of the cross-links of the membrane. The desired extent of disruption of the cross-links of the membrane may in turn be based at least on a desired permeability of the semi-permeable membrane under certain conditions, a desired average pore size, and/or a desired MWCO.

The presence and extent of disrupted cross-links may be determined by examination of the semi-permeable membrane. For example, the loss of cross-links due to chemical disruption may be detected and quantified by observing the presence and/or number of certain atoms or moieties (e.g., terminal functional groups) associated with the chemical dissociation of the cross-links being considered. The presence and/or number of such certain atoms or moieties may be observed using, for example spectroscopic techniques such as infrared (IR) spectroscopy (e.g., Fourier-Transform Infrared (FTIR) spectroscopy) or X-ray photoelectron spectroscopy (XPS). For example, XPS can be used to determine deviations from atomic ratios of certain atoms compared to ratios that would be expected in the absence of disruption of cross-linking. As an illustrative example, a partially oxidized polyamide membrane can be measured by determining the atomic ratio of oxygen to nitrogen using XPS. When polyamide is fully crosslinked, all oxygen atoms and nitrogen atoms in the polyamide polymer form amide groups, resulting in a 1:1 atomic ratio of oxygen to nitrogen. In a fully linear polyamide (thereby lacking cross-links), a free carboxyl group is present for every two amide groups, so the atomic ratio of oxygen to nitrogen is 2:1. Measurements of atomic ratio values between 1:1 and 2:1 can be used to determine extent of disruption of partially-oxidized polyamide accordingly. For example, an atomic ratio of oxygen to nitrogen of 1.5:1 in a polyamide membrane would indicate that 50 mol % of the crosslink are disrupted.

The rejection of each membrane separator may be chosen based on any of a variety of design criteria such as desired purity of permeate, desired hydraulic pressure to be used, and nature of incoming influent (e.g., solute concentration of incoming influent). The rejection, R, of a membrane separator can be calculated from CR (the concentration of solute on the retentate side of the membrane) and C_{P} (the concentration of solute on the permeate side of the membrane) and expressed as a percentage using Equation [6] below:

R=[1−(C_{P}/C_{F})]*100 [6]

In some embodiments, the rejections (R) of the first membrane separator and the second membrane separator (and, if present the third membrane separator) during operation of the method are chosen to afford good, consistent performance across all membrane separators by accounting for differences in concentrations of their respective retentate inlet streams. In some embodiments, the rejection of the first membrane separator for at least one solute (or all solutes) (e.g., the solute during the step of transporting the first membrane separator retentate inlet stream to the retentate side of the first membrane separator) is different than a rejection of the second membrane separator for the for at least one solute (or all solutes) (e.g., the solute during the step of transporting the second membrane separator retentate inlet stream to the retentate side of the second membrane separator). The difference in rejections between the first membrane separator and the second membrane separator may be due, at least in part, to use of different semi-permeable membranes in the first and second membrane separators (e.g., having different pore sizes, MWCOs, and/or surface chemistries). In some embodiments, the rejection of the first membrane separator for at least one solute (or all solute) (e.g., the solute during the step of transporting the first membrane separator retentate inlet stream to the retentate side of the first membrane separator) and the rejection of the second membrane separator for at least one solute (or all solute) (e.g., the solute during the step of transporting the second membrane separator retentate inlet stream to the retentate side of the second membrane separator) are at least 5% different, at least 10% different, at least 20% different, at least 50% different, and/or up to 100% different, or more different from each other. In some embodiments, the rejection of the second membrane separator for at least one solute (or all solutes) (e.g., the solute during the step of transporting the second membrane separator retentate inlet stream to the retentate side of the second membrane separator) is less than that of the first membrane separator for the at least one solute (or all solutes) (e.g., the solute during the step of transporting the first membrane separator retentate inlet stream to the retentate side of the second membrane separator) (e.g., by at least 5%, at least 10%, at least 20%, at least 50%, at least 75%, at least 90%, or more). In some embodiments, the rejection of the second membrane separator for at least one solute (or all solutes) (e.g., the solute during the step of transporting the second membrane separator retentate inlet stream to the retentate side of the second membrane separator) and the rejection of the third membrane separator for at least one solute (or all solute) (e.g., the solute during the step of transporting the third membrane separator retentate inlet stream to the retentate side of the third membrane separator) are at least 5%, at least 10%, at least 20%, at least 50%, and/or up to 100% different, or more different from each other. In some embodiments, the rejection of the third membrane separator for at least one solute (or all solutes) (e.g., the solute during the step of transporting the third membrane separator retentate inlet stream to the retentate side of the third membrane separator) is less than that of the second membrane separator for the at least one solute (or all solutes) (e.g., the solute during the step of transporting the second membrane separator retentate inlet stream to the retentate side of the second membrane separator) (e.g., by at least 5%, at least 10%, at least 20%, at least 50%, at least 75%, at least 90%, or more).

In some embodiments, the rejection for at least one solute (or all solutes) (e.g., the solute during the step of transporting the first membrane separator retentate inlet stream to the retentate side of the first membrane separator) of the first membrane separator is greater than or equal to 10%, greater than or equal to 15%, greater than or equal to 20%, greater than or equal to 50%, greater than or equal to 75%, greater than or equal to 80%, greater than or equal to 85%, greater than or equal to 90%, greater than or equal to 95%, greater than or equal to 98%, greater than or equal to 99%, greater than or equal to 99.9%, or greater. In some embodiments, the rejection for at least one solute (or all solutes) (e.g., the solute during the step of transporting the first membrane separator retentate inlet stream to the retentate side of the first membrane separator) of the first membrane separator is less than or equal to 100%, less than or equal to 99%, less than or equal to 95%, less than or equal to 90%, less than or equal to 85%, less than or equal to 80%, less than or equal to 50%, or less. Combinations of these ranges (e.g., greater than or equal to 10% and less than or equal to 100%) are possible.

In some embodiments, the rejection for at least one solute (or all solutes) of the first membrane separator, second membrane separator, and/or the third membrane separator (if present) are, independently, greater than or equal to 10%, greater than or equal to 15%, greater than or equal to 20%, greater than or equal to 50%, or greater. In some embodiments, the rejection for at least one solute (or all solutes) of the second membrane separator and/or the third membrane separator (if present) are, independently, less than or equal to greater than or equal to 95%, less than or equal to 90%, less than or equal to 85%, less than or equal to 80%, less than or equal to 75%, less than or equal to 60%, less than or equal to 50%, or less. Combinations of these ranges (e.g., greater than or equal to 10% and less than or equal to 95%) are possible.

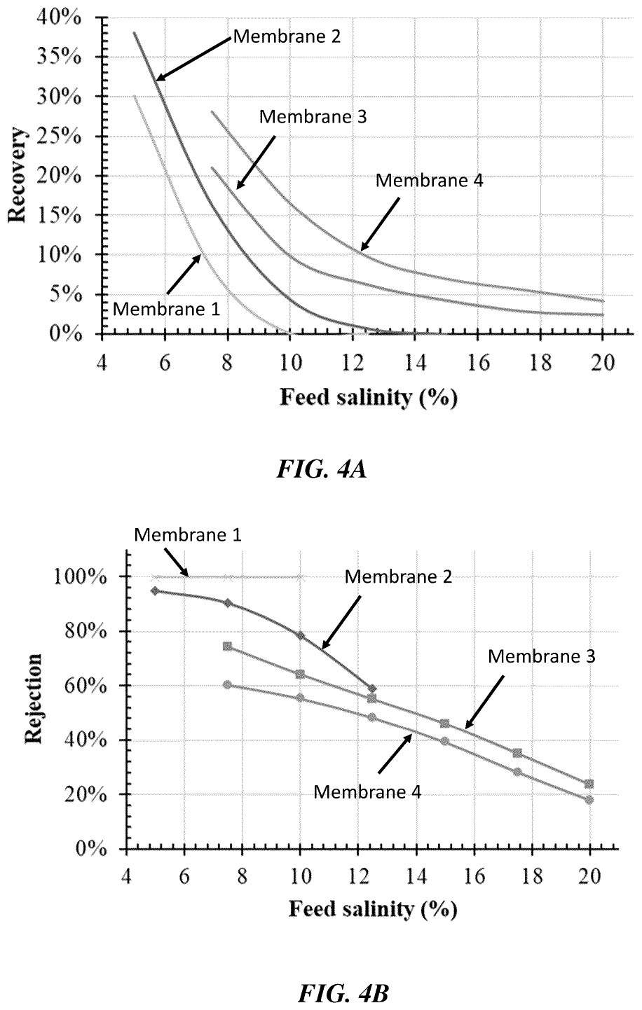

It has been realized in the context of this disclosure that, for a system for performing liquid separations (e.g., for feed stream concentration and/or desalination processes), judicious selection of membranes with varying properties can promote good system performance (e.g., in terms of performing desired separations with fewer components and/or smaller membrane areas). Membrane properties such as permeability, salt passage, pore size, and/or MWCO can affect observed recoveries and rejections. It has also been realized in the context of this disclosure that the recovery and the rejection accomplished by a membrane separator is affected by the solute concentration (e.g., salinity) of the retentate inlet streams. For example, FIGS. 4A-4B show recovery (FIG. 4A) and rejection (FIG. 4B) as a function of feed salinity for four membranes with varying permeability. Membrane 1 has the lowest permeability and highest rejection, while membrane 4 has the highest permeability and lowest rejection. Such membranes can be obtained from any of a variety of sources, such as by obtaining commercially or by modifying commercially available membranes (e.g., polyamide membranes) to achieve the desired permeability. As can be seen in FIGS. 4A-4B, for each membrane, the recovery and rejection decrease with increasing feed salinity. However, it has been realized in the context of this disclosure that a substantially constant recovery (which can be desirable) for a system having multiple membrane separators can be achieved irrespective of feed salinity by utilizing membranes with varying permeability. As an illustrative example, and referring again to FIG. 4A, to achieve 5% recovery, Membrane 1 can be used for 8% salinity feed, Membrane 2 for 10% salinity feed, Membrane 3 for 14% salinity feed and Membrane 4 for a 19% salinity feed.

It has been realized in the context of this disclosure that while recovery can be a good indicator of performance for membrane separators, it does not factor in the effect of decreased rejection (R) at higher feed salinity. It has been determined in the context of this disclosure that solute enhancement factor (CF_{C}), which is a parameter derived from a combination of rejection and recovery, can be used as a basis for arranging a membrane separator system. Solute enhancement factor can either be applied to a single membrane or to a membrane separator (e.g., a membrane separator comprising an array of membranes). The following equation for CF_{C} can be derived from mass balance of a membrane system:

$${CF}_{C} = 1 + ( \frac{( \frac{reco v e r y}{100} )}{1 - ( \frac{r e c o v e r y}{100} )} ) * ( \frac{R}{100} ) \qquad [ 7 ]$$

In Equation [7], the recovery and rejection (R) are divided by 100 because they are defined as percentages. As an illustrative example, if a recovery is 50% and the rejection is R=80%, then the solute enhancement factor would be 1+((50/100)/(1−(50/100))*(80/100)=1+(0.5/0.5)*0.8=1.8.

Accordingly, when operating a system comprising a plurality of membrane separators (e.g., comprising a first membrane separator, a second membrane separator, a third membrane separator), the solute enhancement factor can be measured for each membrane separator. It has been determined in the context of this disclosure that it can be desirable for a system to have a high average solute enhancement factor. In other words, it has been determined that it can be desirable for the arithmetic mean of the solute enhancement factors of each membrane separators to be relatively high. High solute enhancement factors are associated with efficient liquid separation and/or solute concentration enhancement on a per stage basis, which can in turn permit lower capital and/or operational expenditures. In some instances, a relatively high average solute enhancement factor can be facilitated by use of varying membrane permeabilities (and salt passage percentages at standard conditions) for different membrane separators of the system.

In some embodiments in which a plurality of membrane separators are employed, the arithmetic average of the solute enhancement factors of the plurality of membrane separators is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible. In some such embodiments, the arithmetic average of the solute enhancement factors of all membrane separators employed in the method and/or systems is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible.

As one example, in some embodiments in which the first membrane separator and the second membrane separator are used (e.g., as in FIG. 2A), the arithmetic average of the solute enhancement factor of the first membrane separator (e.g., during the step of transporting the first membrane separator retentate inlet stream to the retentate side of the first membrane separator) and the solute enhancement factor of the second membrane separator (e.g., during the step of transporting the second membrane separator retentate inlet stream to the retentate side of the second membrane separator) is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible.

As yet another example, in some embodiments in which the first membrane separator, the second membrane separator, and the third membrane separator are used (e.g., as in FIGS. 3A-3D), the arithmetic average of the solute enhancement factor of the first membrane separator (during the step of transporting the first membrane separator retentate inlet stream to the retentate side of the first membrane separator), the solute enhancement factor of the second membrane separator (during the step of transporting the second membrane separator retentate inlet stream to the retentate side of the second membrane separator), and the solute enhancement factor of the third membrane separator (during the step of transporting the third membrane separator retentate inlet stream to the retentate side of the third membrane separator) is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible.

The solute enhancement factor averages discussed above may be determined for a liquid separation process as described above (e.g., during operation). Alternatively or additionally, the solute enhancement factor averages may be measured for a system based on a screening test performed at 298 K in which a relatively high salinity feed stream containing NaCl as the only solute and water as the only liquid, and having a salinity of 7% is used as the initial input. In some embodiments in which a plurality of membrane separators are employed (e.g., a first membrane separator, a second membrane separator, a third membrane separator), for an initial feed stream containing NaCl as the only solute and water as the only liquid, and having a salinity of 7%, at a temperature of 298 K, the arithmetic average of the solute enhancement factors of the plurality of membrane separators is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible. In some embodiments, for an initial feed stream containing NaCl as the only solute and water as the only liquid, and having a salinity of 7%, at a temperature of 298 K, the arithmetic average of the solute enhancement factors of all of the membrane separators employed is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible. It should be understood that, in this disclosure, when NaCl is referred to as being a solute, at least some (e.g., all) of the NaCl is present in the formed of dissolved Na⁺ and Cl⁻ ions.

Alternatively or additionally, the solute enhancement factor averages may be measured for a system based on a screening test performed at 298 K in which a relatively high salinity feed stream containing NaCl as the only solute and water as the only liquid, and having a salinity of 20% is used as the initial input. In some embodiments in which a plurality of membrane separators are employed (e.g., a first membrane separator, a second membrane separator, a third membrane separator), for an initial feed stream containing NaCl as the only solute and water as the only liquid, and having a salinity of 20%, at a temperature of 298 K, the arithmetic average of the solute enhancement factors of the plurality of membrane separators is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible. In some embodiments, for an initial feed stream containing NaCl as the only solute and water as the only liquid, and having a salinity of 20%, at a temperature of 298 K, the arithmetic average of the solute enhancement factors of all of the membrane separators employed is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible.

As used herein, the salinity of a liquid stream refers to the weight percent (wt %) of all dissolved salts in the liquid stream. Salinity may be measured according to any method known in the art. For example, a non-limiting example of a suitable method for measuring salinity is the SM 2540C method. According to the SM 2540C method, a sample comprising an amount of liquid comprising one or more dissolved solids is filtered (e.g., through a glass fiber filter), and the filtrate is evaporated to dryness in a weighed dish at 180° C. The increase in dish weight represents the mass of the total dissolved solids in the sample. The salinity of the sample may be obtained by dividing the mass of the total dissolved solids by the mass of the original sample and multiplying the resultant number by 100.

In some embodiments, the membrane separators are configured such that relatively little variance in solute enhancement factor occurs among the membrane separators. For example, in some embodiments, in which a plurality of membrane separators is employed in the system, at least two thirds, at least three fourths, at least four fifths, at least five sixths, at least seven eighths, at least nine tenths, or all of the membrane separators of the plurality of membrane separators have a solute enhancement factor within 40%, within 25%, within 10%, within 5%, within 2%, within 1%, or less of the arithmetic average of the solute enhancement factors of the plurality of membrane separators. In some embodiments, at least two thirds, at least three fourths, at least four fifths, at least five sixths, at least seven eighths, at least nine tenths, or all of the membrane separators employed have a solute enhancement factor within 40%, within 25%, within 10%, within 5%, within 2%, within 1%, or less of the arithmetic average of the solute enhancement factors of all of the membrane separators employed. In some embodiments where a first membrane separator and a second membrane separator are employed, the solute enhancement factor of the first membrane separator is within 40%, within 25%, within 10%, within 5%, within 2%, within 1%, or less of the solute enhancement factor of the second membrane separator. In some embodiments where a first membrane separator, a second membrane separator, and a third membrane separator are employed, the solute enhancement factor of each of the first membrane separator, the second membrane separator, and the third membrane separator is within 40%, within 25%, within 10%, within 5%, within 2%, within 1%, or less of the arithmetic average of the solute enhancement factor of the first membrane separator, the solute enhancement factor of the second membrane separator, the solute enhancement factor of the third membrane separator. It has been determined in the context of this disclosure that one way to accomplish a low variance in solute enhancement factor among the membrane separators, which can be beneficial in some instances, including when progressively concentrating a stream, is to modulate the salt passage percentage at standard conditions, permeability, pore size, and/or MWCO of the membrane separators. For example, the semi-permeable membranes may be selected to have progressively greater permeabilities/lower rejections as the feed solutions become progressively more concentrated throughout the process, but while accounting for changes in rejection as well, as described above in the context of FIGS. 4A-4B showing examples of membrane properties.

In some embodiments, the membrane separators are configured such that a relatively large percentage of the membrane separators have a relatively large solute enhancement factor. For example, in some embodiments, in which a plurality of membrane separators is employed in the system, at least two thirds, at least three fourths, at least four fifths, at least five sixths, at least seven eighths, at least nine tenths, or all of the membrane separators of the plurality of membrane separators have a solute enhancement factor of greater than or equal to 1.00, greater than or equal to 1.005, greater than or equal to 1.01, greater than or equal to 1.02, greater than or equal to 1.03, greater than or equal to 1.05, greater than or equal to 1.1, greater than or equal to 1.2, or greater. In some embodiments, at least two thirds, at least three fourths, at least four fifths, at least five sixths, at least seven eighths, at least nine tenths, or all of the membrane separators employed have a solute enhancement factor of greater than or equal to 1.00, greater than or equal to 1.005, greater than or equal to 1.01, greater than or equal to 1.02, greater than or equal to 1.03, greater than or equal to 1.05, greater than or equal to 1.1, greater than or equal to 1.2, or greater. In some embodiments where a first membrane separator and a second membrane separator are employed, the solute enhancement factor of the first membrane separator and the solute enhancement factor of the second membrane separator are both greater than or equal to 1.00, greater than or equal to 1.005, greater than or equal to 1.01, greater than or equal to 1.02, greater than or equal to 1.03, greater than or equal to 1.05, greater than or equal to 1.1, greater than or equal to 1.2, or greater. In some embodiments where a first membrane separator, a second membrane separator, and a third membrane separator are employed, the solute enhancement factor of each of the first membrane separator, the second membrane separator, and the third membrane separator is greater than or equal to 1.00, greater than or equal to 1.005, greater than or equal to 1.01, greater than or equal to 1.02, greater than or equal to 1.03, greater than or equal to 1.05, greater than or equal to 1.1, greater than or equal to 1.2, or greater.

In some embodiments, the methods of this disclosure are performed, and the systems of the disclosure configured, such that the solute enhancement factor ranges and relationships described above (e.g., for arithmetic average among membrane separators, variances, and minimum values) are observed at relatively high cross-flow velocities. Crossflow velocity at a membrane refers to the linear velocity of flow tangential to the membrane surface. For example, the solute enhancement factor ranges and relationships described above may be observed for cross-flow velocities greater than or equal to the minimum crossflow velocity specified by the manufacturer of the semi-permeable membrane(s) of the membrane separator. In some embodiments, the solute enhancement factor ranges and relationships described above may be observed for cross-flow velocities greater than or equal to 0.01 m/s, greater than or equal to 0.1 m/s, greater than or equal to 0.2 m/s, greater than or equal to 0.3 m/s, greater than or equal to 0.4 m/s, greater than or equal to 0.5 m/s, greater than or equal to 0.8 m/s, greater than or equal to 1.0 m/s, greater than or equal to 2.0 m/s, greater than or equal to 5.0 m/s, and/or up to 8 m/s, up to 10 m/s, or higher. Combinations of these ranges are possible.

It has also been determined in the context of this disclosure that mass flow ratio (CF_{M}), which is a parameter derived from the measured recovery of a membrane separator, can be used to arrange a membrane separator system. Mass flow ratio can either be applied to a single membrane or to a membrane separator (e.g., a membrane separator comprising an array of membranes). The following equation for CF_{M} can be derived from mass balance of a membrane system:

$${CF}_{M} = 1 + ( \frac{( \frac{reco v e r y}{100} )}{1 - ( \frac{r e c o v e r y}{100} )} ) \qquad [ 8 ]$$

In Equation [8], the recovery is divided by 100 because recovery is defined as a percentage. As an illustrative example, if a recovery is 50%, then the mass flow ratio would be 1+((50/100)/(1−(50/100))=1+(0.5/0.5)=2.0.

Accordingly, when operating a system comprising a plurality of membrane separators (e.g., comprising a first membrane separator, a second membrane separator, a third membrane separator), the mass flow ratio can be measured for each membrane separator. It has been determined in the context of this disclosure that it can be desirable for a system to have a high average mass flow ratio. In other words, it has been determined that it can be desirable for the arithmetic average of the mass flow ratios of each membrane separators to be relatively high. High mass flow ratios are associated with efficient solute concentration in retentate inlet streams by mass on a per stage basis, which, like in the case of solute enhancement factor described above, can in turn permit lower capital and/or operational expenditures. In some instances, a relatively high average mass flow ratio can be facilitated by use of varying membrane permeabilities (and salt passage percentages at standard conditions) for different membrane separators of the system.

In some embodiments in which a plurality of membrane separators are employed, the arithmetic average of the mass flow ratios of the plurality of membrane separators is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible. In some such embodiments, the arithmetic average of the mass flow ratios of all membrane separators employed in the method and/or systems is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible.

As one example, in some embodiments in which the first membrane separator and the second membrane separator are used (e.g., as in FIG. 2A), the arithmetic average of the mass flow ratio of the first membrane separator (e.g., during the step of transporting the first membrane separator retentate inlet stream to the retentate side of the first membrane separator) and the mass flow ratio of the second membrane separator (e.g., during the step of transporting the second membrane separator retentate inlet stream to the retentate side of the second membrane separator) is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible.

As yet another example, in some embodiments in which the first membrane separator, the second membrane separator, and the third membrane separator are used (e.g., as in FIGS. 3A-3D), the arithmetic average of the mass flow ratio of the first membrane separator (during the step of transporting the first membrane separator retentate inlet stream to the retentate side of the first membrane separator), the mass flow ratio of the second membrane separator (during the step of transporting the second membrane separator retentate inlet stream to the retentate side of the second membrane separator), and the mass flow ratio of the third membrane separator (during the step of transporting the third membrane separator retentate inlet stream to the retentate side of the third membrane separator) is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible.

The mass flow ratio averages discussed above may be determined for a liquid separation process as described above (e.g., during operation). Alternatively or additionally, the mass flow ratio averages may be measured for a system based on a screening test performed at 298 K in which a relatively high salinity feed stream containing NaCl as the only solute and water as the only liquid, and having a salinity of 7% is used as the initial input. In some embodiments in which a plurality of membrane separators are employed (e.g., a first membrane separator, a second membrane separator, a third membrane separator), for an initial feed stream containing NaCl as the only solute and water as the only liquid, and having a salinity of 7%, at a temperature of 298 K, the arithmetic average of the mass flow ratios of the plurality of membrane separators is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible. In some embodiments, for an initial feed stream containing NaCl as the only solute and water as the only liquid, and having a salinity of 7%, at a temperature of 298 K, the arithmetic average of the mass flow ratios of all of the membrane separators employed is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible.

Alternatively or additionally, the mass flow ratio averages may be measured for a system based on a screening test performed at 298 K in which a relatively high salinity feed stream containing NaCl as the only solute and water as the only liquid, and having a salinity of 20% is used as the initial input. In some embodiments in which a plurality of membrane separators are employed (e.g., a first membrane separator, a second membrane separator, a third membrane separator), for an initial feed stream containing NaCl as the only solute and water as the only liquid, and having a salinity of 20%, at a temperature of 298 K, the arithmetic average of the mass flow ratios of the plurality of membrane separators is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible. In some embodiments, for an initial feed stream containing NaCl as the only solute and water as the only liquid, and having a salinity of 20%, at a temperature of 298 K, the arithmetic average of the mass flow ratios of all of the membrane separators employed is greater than or equal to 1.005, greater than or equal to 1.01, greater than or equal to 1.02, greater than or equal to 1.03, greater than or equal to 1.05, greater than or equal to 1.1, greater than or equal to 1.2, and/or up to 1.25, up to 1.3, up to 1.4, up to 1.5, up to 1.8, up to 2.1, or greater. Combinations of these ranges are possible.

In some embodiments, the membrane separators are configured such that relatively little variance in mass flow ratio occurs among the membrane separators. For example, in some embodiments, in which a plurality of membrane separators is employed in the system, at least two thirds, at least three fourths, at least four fifths, at least five sixths, at least seven eighths, at least nine tenths, or all of the membrane separators of the plurality of membrane separators have a mass flow ratio within 40%, within 25%, within 10%, within 5%, within 2%, within 1% or less of the arithmetic average of the mass flow ratios of the plurality of membrane separators. In some embodiments, at least two thirds, at least three fourths, at least four fifths, at least five sixths, at least seven eighths, at least nine tenths, or all of the membrane separators employed have a mass flow ratio within 40%, within 25%, within 10%, within 5%, within 2%, within 1% or less of the arithmetic average of the mass flow ratios of all of the membrane separators employed. In some embodiments where a first membrane separator and a second membrane separator are employed, the mass flow ratio of the first membrane separator is within 40%, within 25%, within 10%, within 5%, within 2%, within 1% or less of the mass flow ratio of the second membrane separator. In some embodiments where a first membrane separator, a second membrane separator, and a third membrane separator are employed, the mass flow ratio of each of the first membrane separator, the second membrane separator, and the third membrane separator is within 40%, within 25%, within 10%, within 5%, within 2%, within 1% or less of the arithmetic average of the mass flow ratio of the first membrane separator, the mass flow ratio of the second membrane separator, the mass flow ratio of the third membrane separator. It has been determined in the context of this disclosure that one way to accomplish a low variance in mass flow ratio among the membrane separators, which can be beneficial in some instances, including when progressively concentrating a stream, is to modulate the salt passage percentage at standard conditions, permeability, pore size, and/or MWCO of the membrane separators. For example, the semi-permeable membranes may be selected to have progressively greater permeabilities/lower rejections as the feed solutions become progressively more concentrated throughout the process, but while accounting for changes in rejection as well, as described above in the context of FIGS. 4A-4B showing examples of membrane properties.

In some embodiments, the membrane separators are configured such that a relatively large percentage of the membrane separators have a relatively large mass flow ratio. For example, in some embodiments in which a plurality of membrane separators is employed in the system, at least two thirds, at least three fourths, at least four fifths, at least five sixths, at least seven eighths, at least nine tenths, or all of the membrane separators of the plurality of membrane separators have a mass flow ratio of greater than or equal to 1.00, greater than or equal to 1.005, greater than or equal to 1.01, greater than or equal to 1.02, greater than or equal to 1.03, greater than or equal to 1.05, greater than or equal to 1.1, greater than or equal to 1.2, or greater. In some embodiments, at least two thirds, at least three fourths, at least four fifths, at least five sixths, at least seven eighths, at least nine tenths, or all of the membrane separators employed have a mass flow ratio of greater than or equal to 1.00, greater than or equal to 1.005, greater than or equal to 1.01, greater than or equal to 1.02, greater than or equal to 1.03, greater than or equal to 1.05, greater than or equal to 1.1, greater than or equal to 1.2, or greater. In some embodiments where a first membrane separator and a second membrane separator are employed, the mass flow ratio of the first membrane separator and the mass flow ratio of the second membrane separator are both greater than or equal to 1.00, greater than or equal to 1.005, greater than or equal to 1.01, greater than or equal to 1.02, greater than or equal to 1.03, greater than or equal to 1.05, greater than or equal to 1.1, greater than or equal to 1.2, or greater. In some embodiments where a first membrane separator, a second membrane separator, and a third membrane separator are employed, the mass flow ratio of each of the first membrane separator, the second membrane separator, and the third membrane separator is greater than or equal to 1.00, greater than or equal to 1.005, greater than or equal to 1.01, greater than or equal to 1.02, greater than or equal to 1.03, greater than or equal to 1.05, greater than or equal to 1.1, greater than or equal to 1.2, or greater.

In some embodiments, the methods of this disclosure are performed, and the systems of the disclosure configured, such that the mass flow ratio ranges and relationships described above (e.g., for arithmetic average among membrane separators, variances, and minimum values) are observed at relatively high cross-flow velocities. For example, the mass flow ratio ranges and relationships described above may be observed for cross-flow velocities greater than or equal to the minimum crossflow velocity specified by the manufacturer of the semi-permeable membrane(s) of the membrane separator. In some embodiments, the mass flow ratio ranges and relationships described above may be observed for cross-flow velocities greater than or equal to 0.01 m/s, greater than or equal to 0.1 m/s, greater than or equal to 0.2 m/s, greater than or equal to 0.3 m/s, greater than or equal to 0.4 m/s, greater than or equal to 0.5 m/s, greater than or equal to 0.8 m/s, greater than or equal to 1.0 m/s, greater than or equal to 2.0 m/s, greater than or equal to 5.0 m/s, and/or up to 8 m/s, up to 10 m/s, or higher. Combinations of these ranges are possible.

In some embodiments, a pressure of any of the streams described herein can be increased via one or more additional components, such as one or more booster pumps. In some embodiments, a pressure of any of the streams described herein can be decreased via one or more additional components, such as one or more additional valves or energy recovery devices. It some embodiments, a membrane separator described herein further comprises one or more heating, cooling, or other concentration or dilution mechanisms or devices.

The membrane separators described herein (e.g., the first membrane separator, the second membrane separator, the third membrane separator) can each include a single semi-permeable membrane or a plurality of semi-permeable membranes.

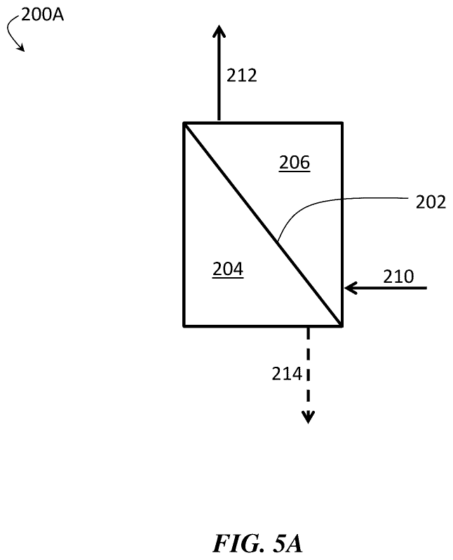

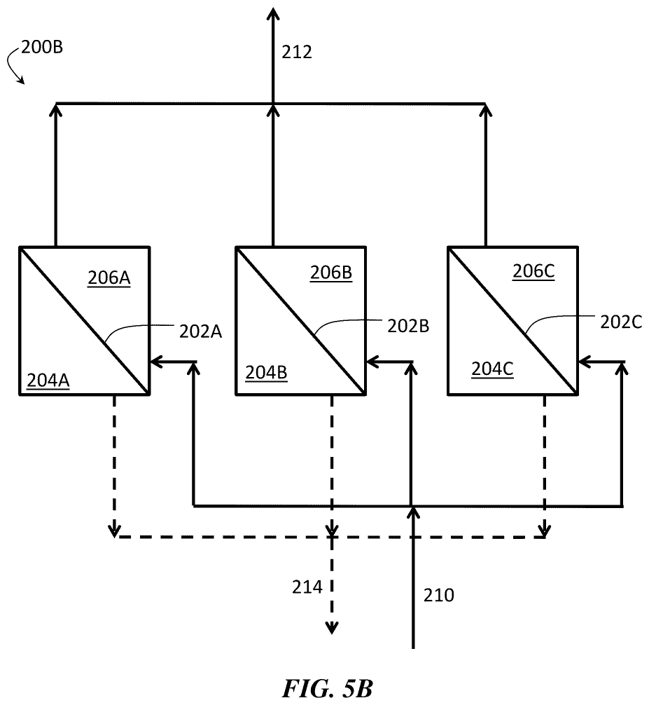

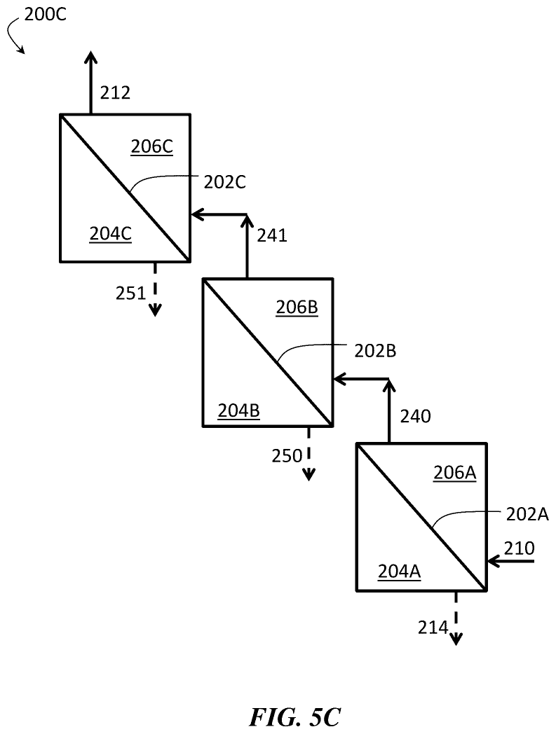

FIG. 5A is a schematic illustration of membrane separator 200A, in which a single semi-permeable membrane is used to separate permeate side 204 from retentate side 206. Membrane separator 200A can be operated by transporting retentate inlet stream 210 across retentate side 206. At least a portion of a liquid (e.g., a solvent) and, in some instances, solute within retentate inlet stream 210 can be transported across semi-permeable membrane 202 to permeate side 204. This can result in the formation of retentate outlet stream 212, which can include a higher concentration of solute than is contained within retentate inlet stream 210, as well as permeate outlet stream 214. Permeate outlet stream 214 can correspond to the liquid (e.g., solvent) and, in some instances, solute, of retentate inlet stream 210 that was transported from retentate side 206 to permeate side 204.

In some embodiments, a membrane separator (e.g., the first membrane separator, the second membrane separator, the third membrane separator) comprises a plurality of semi-permeable membranes connected in parallel. One example of such an arrangement is shown in FIG. 5B. In FIG. 5B, membrane separator 200B comprises three semi-permeable membranes 202A, 202B, and 202C arranged in parallel. Retentate inlet stream 210 is split into three sub-streams, with one sub-stream fed to retentate side 206A of semi-permeable membrane 202A, another sub-stream fed to retentate side 206B of semi-permeable membrane 202B, and yet another sub-stream fed to retentate side 206C of semi-permeable membrane 202C. Membrane separator 200B can be operated by transporting the retentate inlet sub-streams across the retentate sides of the semi-permeable membranes. At least a portion of a liquid (e.g., a solvent), and, in some instances, solute, within retentate inlet stream 210 can be transported across each of semi-permeable membranes 202A, 202B, and 202C to permeate sides 204A, 204B, and 204C, respectively. This can result in the formation of three retentate outlet sub-streams, which can be combined to form retentate outlet stream 212. Retentate outlet stream 212 can include a higher concentration of solute than is contained within retentate inlet stream 210. Permeate outlet stream 214 can also be formed (from three permeate outlet sub-streams). Permeate outlet stream 214 can correspond to the liquid (e.g., solvent), and, in some instances, solute of retentate inlet stream 210 that was transported from retentate sides 206A-206C to permeate sides 204A-204C.

While FIG. 5B shows three semi-permeable membranes connected in parallel, other embodiments could include 2, 4, 5, or more semi-permeable membranes connected in parallel.

In some embodiments, a membrane separator (e.g., the first membrane separator, the second membrane separator) comprises a plurality of semi-permeable membranes connected in series. One example of such an arrangement is shown in FIG. 5C. In FIG. 5C, membrane separator 200C comprises three semi-permeable membranes 202A, 202B, and 202C arranged in series. In FIG. 5C, retentate inlet stream 210 is first transported to retentate side 206A of semi-permeable membrane 202A. At least a portion of a liquid (e.g., a solvent), and, in some instances, solute, within retentate inlet stream 210 can be transported across semi-permeable membrane 202A to permeate side 204A of semi-permeable membrane 202A. This can result in the formation of permeate outlet stream 214 and first intermediate retentate stream 240 that is transported to retentate side 206B of semi-permeable membrane 202B. At least a portion of a liquid (e.g., a solvent), and, in some instances, solute, within first intermediate retentate stream 240 can be transported across semi-permeable membrane 202B to permeate side 204B of semi-permeable membrane 202B. This can result in the formation of permeate outlet stream 250 and second intermediate retentate stream 241 that is transported to retentate side 206C of semi-permeable membrane 202C. At least a portion of a liquid (e.g., a solvent), and, in some instances, solute within second intermediate retentate stream 241 can be transported across semi-permeable membrane 202C to permeate side 204C of semi-permeable membrane 202C. This can result in the formation of permeate outlet stream 251 and retentate outlet stream 212.

While FIG. 5C shows three semi-permeable membranes connected in series, other embodiments could include 2, 4, 5, or more semi-permeable membranes connected in series.

For membrane separators comprising a plurality of semi-permeable membranes, parameters such as rejection percentage, recovery, salt passage percentage at standard conditions, solute enhancement factor, and mass flow ratio for the membrane separators are calculated by performing a mass balance on the entire membrane separator. This means that all initial retentate streams for the membrane separator would be added and considered together, all final permeate outlet streams for the membrane separator would be added and considered together, and all final retentate outlet streams for the membrane separator would be added and considered together. For example, as mentioned above, in FIG. 5B, membrane separator 200B comprises three semi-permeable membranes 202A, 202B, and 202C arranged in parallel. Accordingly, calculation of the composition of the retentate inlet stream of membrane separator 200B for the purpose of calculating parameters such as the rejection percentage, recovery, salt passage percentage at standard conditions, solute enhancement factor, or mass flow ratio for membrane separator 200B would involve taking measurements of retentate inlet stream 210 prior to it being split into the three inlet sub-streams fed to retentate sides 206A, 206B, and 206C of semi-permeable membranes 202A, 202B, and 202C, respectively. Similarly, calculation of the composition of the retentate outlet stream of membrane separator 200B for the purpose of calculating parameters such as the rejection percentage, recovery, salt passage percentage at standard conditions, solute enhancement factor, or mass flow ratio for membrane separator 200B would involve taking measurements of retentate outlet stream 212, which is a combination of the three outlet sub-streams from retentate sides 206A, 206B, and 206C from semi-permeable membranes 202A, 202B, and 202C, respectively. Also similarly, calculation of the composition of the permeate outlet stream of membrane separator 200B for the purpose of calculating parameters such as the rejection percentage, recovery, salt passage percentage at standard conditions, solute enhancement factor, or mass flow ratio for membrane separator 200B would involve taking measurements of permeate outlet stream 214, which is a combination of the three outlet sub-streams from permeate sides 204A, 204B, and 204C from semi-permeable membranes 202A, 202B, and 202C, respectively.

As another example of the calculation of parameters corresponding to a membrane separator comprising a plurality of semi-permeable membranes, reference is made to membrane separator 200C in FIG. 5C. Membrane separator 200C comprises three semi-permeable membranes 202A, 202B, and 202C arranged in series. Accordingly, calculation of the composition of the retentate inlet stream of membrane separator 200C for the purpose of calculating parameters such as the rejection percentage, recovery, salt passage percentage at standard conditions, solute enhancement factor, or mass flow ratio for membrane separator 200C would involve taking measurements of retentate inlet stream 210 prior to it entering semi-permeable membrane 202A because semi-permeable membrane 202A is the initial semi-permeable membrane in the series. Similarly, calculation of the composition of the retentate outlet stream of membrane separator 200C for the purpose of calculating parameters such as the rejection percentage, recovery, salt passage percentage at standard conditions, solute enhancement factor, or mass flow ratio for membrane separator 200C would involve taking measurements of retentate outlet stream 212 exiting semi-permeable membrane 202C because semi-permeable membrane 202C is the final semi-permeable membrane in the series with respect to the retentate outlet streams, thereby making retentate outlet stream 212 the final retentate outlet stream of membrane separator 200C. Calculation of the composition of the permeate outlet stream of membrane separator 200C for the purpose of calculating parameters such as the rejection percentage, recovery, salt passage percentage at standard conditions, solute enhancement factor, or mass flow ratio for membrane separator 200C would involve taking measurements of a combination of permeate outlet streams 214, 250, and 251 exiting semi-permeable membranes 202A, 202B, and 202C respectively. In addition, in some embodiments, a given membrane separator could include multiple semi-permeable membranes connected in parallel as well as multiple semi-permeable membranes connected in series.

In some embodiments, the first membrane separator comprises a plurality of semi-permeable membranes. In some such embodiments, the plurality of semi-permeable membranes within the first membrane separator are connected in series. In some such embodiments, the plurality of semi-permeable membranes within the first membrane separator are connected in parallel. In certain embodiments, the first membrane separator comprises a plurality of membranes a first portion of which are connected in series and another portion of which are connected in parallel.

In some embodiments, the second membrane separator comprises a plurality of semi-permeable membranes. In some such embodiments, the plurality of semi-permeable membranes within the second membrane separator are connected in series. In some such embodiments, the plurality of semi-permeable membranes within the second membrane separator are connected in parallel. In certain embodiments, the second membrane separator comprises a plurality of membranes a first portion of which are connected in series and another portion of which are connected in parallel.

In some embodiments, the third membrane separator comprises a plurality of semi-permeable membranes. In some such embodiments, the plurality of semi-permeable membranes within the third membrane separator are connected in series. In some such embodiments, the plurality of semi-permeable membranes within the third membrane separator are connected in parallel. In certain embodiments, the third membrane separator comprises a plurality of membranes a first portion of which are connected in series and another portion of which are connected in parallel.

The systems and methods described herein can be used to process a variety of feed streams. Generally, the feed stream comprises at least one liquid and at least one solute (also referred to herein as a solubilized species). According to certain embodiments, the feed stream comprises solubilized ions as a solute. The solubilized ion(s) may originate, for example, from a salt that has been dissolved in the liquid (e.g., solvent(s)) of the feed stream. A solubilized ion is generally an ion that has been solubilized to such an extent that the ion is no longer ionically bonded to a counter-ion. The feed stream can comprise any of a variety of solutes (e.g., solubilized ions) including, but not limited to, Na⁺, Mg²⁺, Ca²⁺, Sr²⁺, Ba²⁺, Cl⁻, ammonia cations, carbonate anions, bicarbonate anions, sulfate anions, bisulfate anions, and/or silica. In some embodiments, a feed stream (e.g., an aqueous feed stream) comprises at least one solubilized monovalent cation (i.e., a cation with a redox state of +1 when solubilized). For example, in some embodiments, a feed stream (e.g., an aqueous feed stream) comprises Na⁺ and/or K⁺. In certain embodiments, a feed stream (e.g., an aqueous feed stream) comprises at least one monovalent anion (i.e., an anion having redox state of −1 when solubilized). For example, in some embodiments, a feed stream (e.g., an aqueous feed stream) comprises Cl⁻ and/or Br⁻. In some embodiments, a feed stream (e.g., an aqueous feed stream) comprises at least one monovalent cation and at least one monovalent anion. In some embodiments, a feed stream (e.g., an aqueous feed stream) comprises one or more divalent cations (i.e., a cation with a redox state of +2 when solubilized) and/or one or more divalent anions (i.e., an anion with a redox state of −2 when solubilized). Cations and/or anions having other valencies may also be present in feed streams (e.g., an aqueous feed stream), in some embodiments.

In some embodiments, the total concentration of solubilized ions in the feed stream can be relatively high. One advantage associated with certain embodiments is that initial feed streams (e.g., aqueous feed streams) with relatively high solubilized ion concentrations can be desalinated without the use of energy intensive desalination methods. In certain embodiments, the total concentration of solubilized ions in the feed stream transported into the system is at least 60,000 ppm, at least 80,000 ppm, or at least 100,000 ppm (and/or, in some embodiments, up to 200,000, up to 500,000 ppm, or more). Feed streams with solubilized ion concentrations outside these ranges could also be used.

According to certain embodiments, the feed stream that is transported to the system comprises a suspended and/or emulsified immiscible phase. Generally, a suspended and/or emulsified immiscible phase is a material that is not soluble in in the liquid of the feed stream (e.g., solvent such as water) to a level of more than 10% by weight at the temperature and other conditions at which the stream is operated. In some embodiments, the suspended and/or emulsified immiscible phase comprises oil and/or grease. The term “oil” generally refers to a fluid that is more hydrophobic than water and is not miscible or soluble in water, as is known in the art. Thus, the oil may be a hydrocarbon in some embodiments, but in other embodiments, the oil may comprise other hydrophobic fluids. In some embodiments, at least 0.1 wt %, at least 1 wt %, at least 2 wt %, at least 5 wt %, or at least 10 wt % (and/or, in some embodiments, up to 20 wt %, up to 30 wt %, up to 40 wt %, up to 50 wt %, or more) of a feed stream (e.g., an aqueous feed stream) is made up of a suspended and/or emulsified immiscible phase.

While one or more of the membrane separators (e.g., the first membrane separator, the second membrane separator, the third membrane separator) can be used to separate a suspended and/or emulsified immiscible phase from an incoming feed stream, such separation is optional. For example, in some embodiments, the feed stream transported to the system is substantially free of a suspended and/or emulsified immiscible phase. In certain embodiments, one or more separation units upstream of the system can be used to at least partially remove a suspended and/or emulsified immiscible phase from a feed stream (e.g., an aqueous feed stream) before the feed stream is transported to a membrane separator. Non-limiting examples of such systems are described, for example, in International Patent Publication No. WO 2015/021062, published on Feb. 12, 2015, which is incorporated herein by reference in its entirety for all purposes.

In some embodiments, the feed stream can be derived from seawater, ground water, brackish water, water used in or wastewater resulting from mining processes, wastewater from semiconductor manufacturing, wastewater from textile manufacturing, salar brines, wastewater from pharmaceutical manufacturing, and/or the effluent of a chemical process. In the oil and gas industry, for example, one type of aqueous feed stream that may be encountered is produced water (e.g., water that emerges from oil or gas wells along with the oil or gas). Due to the length of time produced water has spent in the ground, and due to high subterranean pressures and temperatures that may increase the solubility of certain salts and minerals, produced water often comprises relatively high concentrations of dissolved salts and minerals. For example, some produced water streams may comprise a supersaturated solution of dissolved strontium sulfate (SrSO₄). In contrast, another type of aqueous feed stream that may be encountered in the oil and gas industry is flowback water (e.g., water that is injected as a fracking fluid during hydraulic fracturing operations and subsequently recovered). Flowback water often comprises a variety of constituents used in fracking, including surfactants, proppants, and viscosity reducing agents, but often has a lower salinity than produced water. In some cases, the systems and methods described herein can be used to at least partially desalinate aqueous feed streams derived from such process streams.

A variety of types of liquids could also be used in the feed stream. In some embodiments, the liquid of the feed stream comprises water. For example, in some embodiments, at least 10 wt %, at least 25 wt %, at least 50 wt %, at least 75 wt %, at least 90 wt %, at least 95 wt %, at least 98 wt %, at least 99 wt %, at least 99.9 wt %, or more (e.g., all) of the liquid is water. Other examples of potential liquids for the feed steam include, but are not limited to alcohols and/or hydrocarbons. The liquid of the feed stream may be a mixture of different liquid-phase species. For example, the liquid may be a mixture of water and a water-miscible organic liquid, such as an alcohol.

It should be understood that, in the present disclosure, the word “purified” (and, similarly, “pure” and “purify”) is used to describe any liquid that contains the component of interest in a higher percentage than is contained within a reference stream, and does not necessarily require that the liquid be 100% pure. That is to say, a “purified” stream can be partially or completely purified. As a non-limiting example, a water stream may be made up of 80 wt % water but could still be considered “purified” relative to a feed stream that is made up of 50 wt % water. Of course, it should also be understood that, in some embodiments, the “purified” stream could be made up of only (or substantially only) the component of interest. For example, a “purified” water stream could be made up of substantially only water (e.g., water in an amount of at least 98 wt %, at least 99 wt %, or more, or at least 99.9 wt %) and/or could be made up of only water (i.e., 100 wt % water).

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

As used herein, two elements are fluidically connected to each other when they are connected such that, under at least one configuration of the elements and any intervening elements, the two elements are in fluidic communication with each other. Two membrane separators connected by a valve and conduits that permit flow between the membrane separators in at least one configuration of the valve would be said to be fluidically connected to each other. To further illustrate, two membrane separators that are connected by a valve and conduits that permit flow between the membrane separators in a first valve configuration but not a second valve configuration are considered to be fluidically connected to each other both when the valve is in the first configuration and when the valve is in the second configuration. In contrast, two membrane separators that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Various components are described herein as being fluidically connected. Fluidic connections may be either direct fluidic connections or indirect fluidic connections. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least 50 wt % (or at least 75 wt %, at least 90 wt %, at least 95 wt %, or at least 98 wt %) of the fluid (e.g., liquid) in the first region is transported to the second region via the direct fluidic connection. Any of the fluidic connections described herein may be, in some embodiments, direct fluidic connections. In other cases, the fluidic connections may be indirect fluidic connections.

In some embodiments, the retentate side of the first membrane separator is fluidically connected to the retentate side of the second membrane separator. For example, in FIGS. 2-3D and 8A-9C, retentate side 103 of first membrane separator 102 may be fluidically connected to retentate side 109 of second membrane separator 108. Such a fluidic connection may facilitate transport of at least a portion of the first membrane separator retentate side outlet stream from the retentate side of the first membrane separator (e.g., from a retentate side outlet of the first membrane separator) to the retentate side of the second membrane separator (e.g., by forming some or all of a second membrane separator retentate inlet stream that enters a retentate side inlet of the second membrane separator). In some embodiments, the retentate side of the first membrane separator is directly fluidically connected to the retentate side of the second membrane separator. For example, in FIGS. 2, 3A, 3C-3D and 9B-9C, retentate side 103 of first membrane separator 102 may be directly fluidically connected to retentate side 109 of second membrane separator 108.

In some embodiments, the permeate side of the second membrane separator is fluidically connected to the retentate side of the first membrane separator. Such a fluidic connection may establish a recycle stream, as discussed above. For example, in FIGS. 3B and 3D and FIGS. 8B, 8D, 9A, and 9C, permeate side 110 of second membrane separator 108 may be fluidically connected to retentate side 103 of first membrane separator 102. Such a fluidic connection may facilitate transport of at least a portion of the second membrane separator permeate outlet stream from the permeate side of the second membrane separator (e.g., from a permeate side outlet of the second membrane separator) to the retentate side of the first membrane separator (e.g., by forming a portion of the first membrane separator retentate inlet stream that enters the retentate side inlet of the first membrane separator). In some embodiments, the permeate side of the second membrane separator is directly fluidically connected to the retentate side of the first membrane separator. For example, in FIGS. 8B and 9A, permeate side 110 of second membrane separator 108 may be directly fluidically connected to retentate side 103 of first membrane separator 102.

In some embodiments, the retentate side of the second membrane separator is fluidically connected to the retentate side of the third membrane separator. For example, in FIGS. 3A-3D and 8B-9C, retentate side 109 of second membrane separator 108 may be fluidically connected to retentate side 115 of third membrane separator 114. Such a fluidic connection may facilitate transport of at least a portion of the second membrane separator retentate side outlet stream from the retentate side of the second membrane separator (e.g., from a retentate side outlet of the first membrane separator) to the retentate side of the third membrane separator (e.g., by forming some or all of a third membrane separator retentate inlet stream that enters a retentate side inlet of the third membrane separator). In some embodiments, the retentate side of the second membrane separator is directly fluidically connected to the retentate side of the third membrane separator. For example, in FIGS. 3A-3D and 8A-8D, retentate side 109 of second membrane separator 108 may be directly fluidically connected to retentate side 115 of third membrane separator 114.

In some embodiments, the permeate side of the third membrane separator is fluidically connected to the retentate side of the second membrane separator. Such a fluidic connection may establish a recycle stream, as discussed above. For example, in FIG. 3B and FIGS. 8B and 9A, permeate side 116 of third membrane separator 114 may be fluidically connected to retentate side 109 of second membrane separator 108. Such a fluidic connection may facilitate transport of at least a portion of the third membrane separator permeate side outlet stream from the permeate side of the third membrane separator (e.g., from a permeate outlet of the third membrane separator) to the retentate side of the second membrane separator (e.g., by forming a portion of the second membrane separator retentate inlet stream that enters the retentate side inlet of the second membrane separator). In some embodiments, the permeate side of the third membrane separator is directly fluidically connected to the retentate side of the second membrane separator.

In some embodiments, the permeate side of the third membrane separator is fluidically connected to the retentate side of the first membrane separator. Such a fluidic connection may establish a recycle stream, as discussed above. For example, in FIGS. 3C-3D, 8C-8D, and 9B-9C, permeate side 116 of third membrane separator 114 may be fluidically connected to retentate side 103 of first membrane separator 102. Such a fluidic connection may facilitate transport of at least a portion of the third membrane separator permeate side outlet stream from the permeate side of the third membrane separator (e.g., from a permeate outlet of the third membrane separator) to the retentate side of the first membrane separator (e.g., by forming a portion of the first membrane separator retentate inlet stream that enters the retentate side inlet of the first membrane separator). In some embodiments, the permeate side of the third membrane separator is directly fluidically connected to the retentate side of the first membrane separator. For example, in FIGS. 8C and 9B, permeate side 116 of third membrane separator 114 may be directly fluidically connected to retentate side 103 of first membrane separator 102.

In some embodiments, the permeate side of the second membrane separator and the permeate side of the third membrane separator are each fluidically connected to the retentate side of the first membrane separator. Such a fluidic connection may establish multiple recycle streams. For example, in FIG. 3D, FIG. 8D, and FIG. 9C, permeate side 110 of second membrane separator 108 and permeate side 116 of third membrane separator 114 may each be fluidically connected to retentate side 103 of first membrane separator 102. Such fluidic connections may facilitate transport of at least a portion of the second membrane separator permeate side outlet stream from the permeate side of the second membrane separator (e.g., from a permeate outlet of the second membrane separator) and at least a portion of the third membrane separator permeate side outlet stream from the permeate side of the third membrane separator (e.g., from a permeate outlet of the third membrane separator) to the retentate side of the first membrane separator (e.g., by forming a portion of the first membrane separator retentate inlet stream that enters the retentate side inlet of the first membrane separator).

U.S. Provisional Patent Application No. 63/389,677, filed Jul. 15, 2022, and entitled “Liquid Separation Using Solute-Permeable Membranes and Related Systems,” and U.S. Provisional Patent Application No. 63/411,079, filed Sep. 28, 2022, and entitled “Liquid Separation Using Solute-Permeable Membranes and Related Systems,” are each incorporated herein by reference in its entirety for all purposes.

### EXAMPLE EMBODIMENT

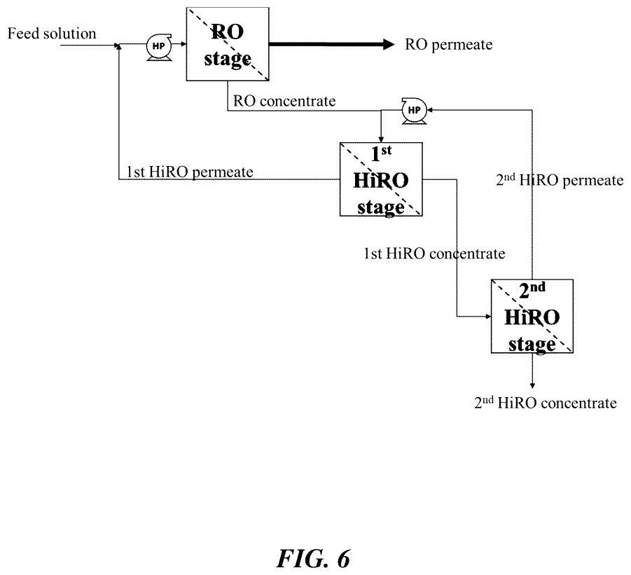

A description of one non-limiting example of an embodiment of a system designed and arranged according to the teachings of this disclosure is provided as follows. This embodiment is also shown using the flow diagram in FIG. 6.

The system comprises a first membrane separator configured as a high-rejection reverse osmosis stage denoted as “RO stage” in FIG. 6. The system further comprises at least one additional membrane separator having a higher solute permeability than the RO stage, with the higher-permeability membrane separators referred to in this example description as “HiRO” stages. In the embodiment shown in FIG. 6, the system comprises two HiRO stages denoted as “1^{st} HiRO stage” and “2^{nd} HiRO stage.” The system further comprises high pressure pumps (“HP” in FIG. 6), including an influent pump and HiRO permeate pump(s).

The RO stage comprises at least one semi-permeable membrane. The membranes may be arranged in parallel, in series, or a combination of parallel or serial arrays. The number of membranes may be dependent on design criteria such as influent concentration, flow rate, and/or hydraulic pressure. In the system of this example, the membrane area of the RO stage is 120 m², influent into the RO stage (comprising a feed solution and the 1^{st} HiRO permeate in FIG. 6) has 5% salinity, and that influent is flowed at 2.5 m³/h and with a hydraulic pressure of 70 bar (7000 kPa). Most commercial reverse osmosis membranes are suitable for this application.

In this example embodiment, each HiRO stage comprises at least one higher-permeability membrane arranged in parallel, series, or a combination thereof. The membrane(s) of the HiRO stages membrane are selected to have a salt permeation rate of 15 to 85% for saline streams containing 7 to 20% salinity. Salt generally permeates by diffusion, and the rate of diffusion depends on the magnitude of the salt concentration and the permeability of membrane. Like salt permeation rate, the water permeability of a HiRO membrane is also dependent on stream salinity and the permeability of membrane. It has been realized in the context of this disclosure that if the same exact membrane is used for all HiRO stages, the water permeation rate may decrease as a function of salinity and the solute enhancement factor and mass flow ratio will drop substantially. In this example system, two different membranes are utilized in 1^{st} HiRO stage and the 2^{nd} HiRO stage. This use of two different membranes with two different solute permeabilities results in a solution enhancement factor of 1.3 for both 1^{st} HiRO stage and the 2^{nd} HiRO stage. However, it has been determined that if the same membrane is used in the 1^{st} HiRO stage and the 2^{nd} HiRO stage, the solute enhancement factor for 1^{st} HiRO stage will be 1.3 while that of the 2^{nd} HiRO stage will be 0.9. It has been determined that for HiRO stage-containing systems with a greater number of stages, the drop in solute enhancement factor and/or mass flow ratio for consecutive stages will be more pronounced and the stages receiving influent with higher salinity will be less productive. Accordingly, use of membrane separators with varying permeabilities can promote relatively high and/or consistent solute enhancement factors and/or mass flow ratios for all stages in the system.

HiRO membranes in this example can be spiral wound, hollow fiber, flat sheet, and/or ceramic. Membranes used for HiRO stages can obtained in any of a variety of manners. For example, the membranes used for the HiRO stages can be purchased commercially, if available, or manufactured via chemical treatment of commercially available membranes. In this example system, the first HiRO stage has a membrane area of 60 m² and the second HiRO stage has an area of 60 m².

In this example system, the feed pump and HiRO stage permeate pumps may be any of a variety of types of high-pressure pump capable of producing pressures up to 120 bar of hydraulic pressure. For example, the pumps (HP in FIG. 6) may be multi-stage centrifugal pumps, piston pumps, lobe pumps, or combinations thereof. A source of feed solution is fluidically connected the feed pump. Examples of suitable sources include, but are not limited to, membrane desalination brine streams, thermal desalination brine streams, and saline groundwater. Referring again to FIG. 6, operation of the RO stage results in production of an RO permeate stream and an RO concentrate stream (corresponding to a retentate outlet stream from the RO stage). The RO concentrate is fed to the retentate side of the 1^{st} HiRO stage, where a portion of liquid and solute from the 1^{st} HiRO retentate influent is passed through the membrane of the 1^{st} HiRO stage to form the 1^{st} HiRO permeate, which can optionally be fed back to the original feed solution. The retentate outlet stream (1^{st} HiRO concentrate in FIG. 6) exiting the 1^{st} HiRO stage is fed to the retentate side of the 2^{nd} HiRO stage, where a portion of liquid and solute from the 2^{nd} HiRO retentate influent is passed through the membrane of the 2^{nd} HiRO stage to form the 2^{nd} HiRO permeate, which can optionally be fed back to the 1st HiRO stage influent.

### Example Design Process and Comparison

A description of a non-limiting embodiment of a system designed and arranged according to the teachings of this disclosure, and a comparison with a comparative system, are now provided. In this example comparison, a membrane separator system with liquid separation performance at relatively low capital and operating expenditure is realized by employing membranes with increased permeability for stages that encounter higher salinity brines. The non-limiting cases in FIGS. 7A-7B show a comparison between (a) a process designed with a constant permeability across all membrane separators due to use of the same membrane for each separator (FIG. 7A), and (b) a process designed with a combination of different membranes used for the different membrane separators. The design of the inventive process shown in FIG. 7B involves selecting different membrane permeabilities for each membrane separator (taking into account feed salinities, flow rates, and pressures) to afford relativity high solute enhancement factors and mass flow ratios for each stage. The systems in FIGS. 7A-7B use high pressure pumps denoted as ‘HP’ and are operated at 80 bar pressure. Stage 1 is a membrane separator operated using high-rejection (e.g., 100% rejection) RO, whereas the remaining membrane separators are “HiRO” stages with progressively higher membrane permeabilities. The systems of both FIG. 7A and FIG. 7B are designed for a 75,000 mg/L brine concentration feed, at a 3.5 m³/hr feed flow rate, and with a water recovery of 65%. The final brine concentration is 211,000 mg/L. In the comparative system shown in FIG. 7A, the components are denoted as follows: the feed stream is B0, the high pressure pump is HP, the seven membrane separator stages are denoted 1-7 in order, each producing a retentate outlet stream (B1, B2, B3, B4, B5, B6, B7, respectively) and a permeate outlet stream (P, P1, P2, P3, P4, P5, P6, P7, respectively). In the non-limiting inventive example system shown in FIG. 7B, the components are denoted as follows: the feed stream is B0, the high pressure pump is HP, the five membrane separator stages are denoted 1-5 in order, each producing a retentate outlet stream (B1, B2, B3, B4, B5, respectively) and a permeate outlet stream (P, P1, P2, P3, P4, P5, respectively).

Table 1 shows solute enhancement factor (CF_{C}) values for the comparative process of FIG. 7A and the inventive example process of FIG. 7B, along with the membrane areas required to achieve the desired water recovery. The process of FIG. 7B, where the membrane permeability of each membrane was selected to promote high solute enhancement factors, is able to achieve an average CF_{C} of 1.2 as compared to 1.13 for the comparative process. This 6% higher CF_{C} allows for employment of fewer membrane separators and a 17% drop in the required membrane area for the desired water recovery for the system of FIG. 7B, which can result in significant cost savings by reducing capital and operating expenditure.

TABLE 1
Solute enhancement (CF_{C}) values and membrane area for membrane
separators of the comparative example process shown in FIG.
7A and the inventive example process shown in FIG. 7B

CF_{C}

| | Comparative Example | Inventive |
|---|---|---|
| | (constant membrane | Example (varying |
| Membrane | permeability for all | permeability among |
| Separator | membrane separators) | membrane separators) |
| 2 | 1.368 | 1.358 |
| 3 | 1.164 | 1.213 |
| 4 | 1.093 | 1.101 |
| 5 | 1.074 | 1.117 |
| 6 | 1.039 | — |
| 7 | 1.043 | — |
| Membrane area | 1823 | 1512 |
| required (m²) | | |

The selection of membrane permeabilities for each membrane separator in the inventive example process shown in FIG. 7B can be performed, for example, by specifying a target concentrate salinity and varying the number of pressure vessels and stages in a modeled system in which permeate is always routed to a point of closest salinity. Configurations with desired performance may be selected based on, for example, the highest average CF_{C} value. It has been realized that this process of selection and design based on increasing average solution enhancement factor (and/or mass flow ratio) can result in configurations with the lowest membrane area and/or the lowest energy expenditure required to reach the target concentrate salinity.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1-34. (canceled)

35. A system, comprising:
a plurality of membrane separators comprising:
a first membrane separator comprising at least one semi-permeable membrane defining a retentate side of the first membrane separator and a permeate side of the first membrane separator; and
a second membrane separator comprising at least one semi-permeable membrane defining a retentate side of the second membrane separator and a permeate side of the second membrane separator;
wherein:
the retentate side of the first membrane separator is fluidically connected to the retentate side of the second membrane separator;
the first membrane separator has a different salt passage percentage at standard conditions than the second membrane separator, wherein the salt passage percentage at standard conditions is determined using ASTM D4516-19a; and
for an initial feed stream containing NaCl as the only solute and water as the only liquid, and having a salinity of 7%, at a temperature of 298 K, each of the plurality of membrane separators has a solute enhancement factor, and the arithmetic average of the solute enhancement factors of the plurality of membrane separators is greater than or equal to 1.005.

36. A system, comprising:
a plurality of membrane separators comprising:
a first membrane separator comprising at least one semi-permeable membrane defining a retentate side of the first membrane separator and a permeate side of the first membrane separator; and
a second membrane separator comprising at least one semi-permeable membrane defining a retentate side of the second membrane separator and a permeate side of the second membrane separator;
wherein:
the retentate side of the first membrane separator is fluidically connected to the retentate side of the second membrane separator;
the first membrane separator has a different salt passage percentage at standard conditions than the second membrane separator, wherein the salt passage percentage at standard conditions is determined using ASTM D4516-19a; and
for an initial feed stream containing NaCl as the only solute and water as the only liquid, and having a salinity of 20%, at a temperature of 298 K, each of the plurality of membrane separators has a solute enhancement factor, and the arithmetic average of the solute enhancement factors of the plurality of membrane separators is greater than or equal to 1.005.

37. A system, comprising:
a plurality of membrane separators comprising:
a first membrane separator comprising at least one semi-permeable membrane defining a retentate side of the first membrane separator and a permeate side of the first membrane separator; and
a second membrane separator comprising at least one semi-permeable membrane defining a retentate side of the second membrane separator and a permeate side of the second membrane separator;
wherein:
the retentate side of the first membrane separator is fluidically connected to the retentate side of the second membrane separator;
the first membrane separator has a different salt passage percentage at standard conditions than the second membrane separator, wherein the salt passage percentage at standard conditions is determined using ASTM D4516-19a; and
for an initial feed stream containing NaCl as the only solute and water as the only liquid, and having a salinity of 7%, at a temperature of 298 K, each of the plurality of membrane separator has a mass flow ratio, and the arithmetic average of the mass flow ratios of the plurality of membrane separators is greater than or equal to 1.005.

38. A system, comprising:
a plurality of membrane separators comprising:
a first membrane separator comprising at least one semi-permeable membrane defining a retentate side of the first membrane separator and a permeate side of the first membrane separator; and
a second membrane separator comprising at least one semi-permeable membrane defining a retentate side of the second membrane separator and a permeate side of the second membrane separator;
wherein:
the retentate side of the first membrane separator is fluidically connected to the retentate side of the second membrane separator;
the first membrane separator has a different salt passage percentage at standard conditions than the second membrane separator, wherein the salt passage percentage at standard conditions is determined using ASTM D4516-19a; and
for an initial feed stream containing NaCl as the only solute and water as the only liquid, and having a salinity of 20%, at a temperature of 298 K, each of the plurality of membrane separator has a mass flow ratio, and the arithmetic average of the mass flow ratios of the plurality of membrane separators is greater than or equal to 1.005.

39. A membrane separator comprising at least one semi-permeable membrane defining a retentate side of the membrane separator and a permeate side of the membrane separator, wherein for an initial feed stream containing NaCl as the only solute and water as the only liquid, and having a salinity of 7%, at a temperature of 298 K, the membrane separator has a solute enhancement factor and/or mass flow ratio of greater than or equal to 1.005.

40. A membrane separator comprising at least one semi-permeable membrane defining a retentate side of the membrane separator and a permeate side of the membrane separator, wherein for an initial feed stream containing NaCl as the only solute and water as the only liquid, and having a salinity of 20%, at a temperature of 298 K, the membrane separator has a solute enhancement factor and/or mass flow ratio of greater than or equal to 1.005.

41. The system of claim 35, wherein the salt passage percentage at standard conditions of the first membrane separator and the salt passage percentage at standard conditions of the second membrane separator are at least 5% different from each other.

42. The system of claim 35, wherein the second membrane separator has a salt passage percentage at standard conditions that is greater than that of the first membrane separator.

43. The system of claim 35, wherein the second membrane separator has a salt passage percentage at standard conditions that is greater than that of the first membrane separator by a factor of at least 1.05.

44. The system of claim 35, wherein at least two thirds of the membrane separators of the plurality of membrane separators have a solute enhancement factor within 40% of the arithmetic average of the solute enhancement factors of the plurality of membrane separators.

45. The system of claim 35, wherein each of the membrane separators of the plurality of membrane separators has a solute enhancement factor within 40% of the arithmetic average of the solute enhancement factors of the plurality of membrane separators.

46. The system of claim 37, wherein at least two thirds of the membrane separators of the plurality of membrane separators have a mass flow ratio within 40% of the arithmetic average of the mass flow ratios of the plurality of membrane separators.

47. The system of claim 37, wherein each of the membrane separators of the plurality of membrane separators has a mass flow ratio within 40% of the arithmetic average of the mass flow ratio of the plurality of membrane separators.

48. The system of claim 35, wherein the system is configured to transport a liquid stream from the retentate side of the first membrane separator to the retentate side of the second membrane separator.

49. The system of claim 35, wherein the permeate side of the second membrane separator is fluidically connected to the retentate side of the first membrane separator.

50. The system of claim 35, wherein the system is configured to transport a liquid stream from the permeate side of the second membrane separator to the retentate side of the first membrane separator.

51. The system of claim 35, wherein the second membrane separator has a rejection for at least one solute at a given solute concentration on the retentate side that is less than that of the first membrane separator.

52. The system of claim 35, wherein the second membrane separator has a rejection for at least one solute on the retentate side that is less than that of the first membrane separator by at least 5%.

53. The system of claim 35, wherein the at least one semi-permeable membrane of the second membrane separator has an average molecular weight cutoff (MWCO) that is greater than that of the at least one semi-permeable membrane of the first membrane separator.

54. The system of claim 35, wherein the at least one semi-permeable membrane of the second membrane separator has an average molecular weight cutoff (MWCO) that is greater than that of the at least one semi-permeable membrane of the first membrane separator by a factor of at least 1.05.

55. The system of claim 35, wherein the at least one semi-permeable membrane of the first membrane separator and/or the at least one semi-permeable membrane of the second membrane separator has an average MWCO of less than or than or equal to 400 Daltons.

56. The system of claim 35, wherein the at least one semi-permeable membrane of the first membrane separator and/or the at least one semi-permeable membrane of the second membrane separator has an average MWCO of greater than or equal to 50 Daltons.

57. The system of claim 35, wherein the first membrane separator and/or the second membrane separator has a rejection for at least one solute of less than or equal to 95%.

58. The system of claim 35, wherein the first membrane separator and/or the second membrane separator has a rejection for at least one solute of greater than or equal to 10%.

59. The system of claim 35, wherein the first membrane separator has a total membrane surface area that is different than a total membrane surface area of the second membrane separator.

60. The system of claim 35, wherein the at least one semi-permeable membrane of the first membrane separator and/or the at least one semi-permeable membrane of the second membrane separator has cross-links, with at least some of the cross-links being disrupted.

61. The system of claim 35, wherein the at least one semi-permeable membrane of the first membrane separator and/or the at least one semi-permeable membrane of the second membrane separator has cross-links, with at least some of the cross-links being chemically disrupted.

62. The system of claim 35, wherein the at least one semi-permeable membrane of the first membrane separator and/or the at least one semi-permeable membrane of the second membrane separator comprises an active layer comprising a cross-linked polymeric material derived from monomers, and wherein fewer than or equal to 99.9 mol % of the monomers participate in at least one cross-link.

63. The system of claim 35, wherein the first membrane separator and/or the second membrane separator comprises a plurality of semi-permeable membranes.

64. The system of claim 63, wherein the plurality of semi-permeable membranes is connected in series.

65. The system of claim 63, wherein the plurality of semi-permeable membranes is connected in parallel.

66. The system of claim 35, wherein the plurality of membrane separators further comprises a third membrane separator comprising at least one semi-permeable membrane defining a retentate side of the third membrane separator and a permeate side of the third membrane separator.

67. The system of claim 66, wherein the system is configured to transport a liquid stream from the retentate side of the second membrane separator to the retentate side of the third membrane separator.

68. The system of claim 66, wherein the permeate side of the third membrane separator is fluidically connected to the retentate side of the second membrane separator.
